(19) United States
(12) Patent Application Publication
(10) Pub. No.: US 2004/0093439 A1
(43) Pub. Date: May 13, 2004

(54) Data processing control apparatus and DMA controller

(75) Inventors: Hiroshi Miura, Kyoto-shi (JP); Hirofumi Inada, Kyoto-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: ROHM CO., LTD

(21) Appl. No.: 10/668,359

(22) Filed: Sep. 24, 2003

(30) Foreign Application Priority Data
Sep. 24, 2002 (JP) 2002-277276
Sep. 24, 2002 (JP) 2002-277289
Sep. 24, 2002 (JP) 2002-277298

(51) Int. Cl. G06F 13/28

(52) U.S. Cl. 710/22

(57) ABSTRACT

A DMA controller has a setting register, an operation register, and a setting execution register for storing transfer conditions under which to transfer, by DMA transfer, the transfer conditions for DMA transfer from an external memory to the setting register. The DMA controller also has a multiplexer for alternatively selecting one of the setting register and the setting execution register. The DMA controller further has a controller for performing control so that the selected register is switched alternately between the setting register and the setting execution register every time DMA transfer ends, and a controller for performing control so that, when DMA transfer is started, the data stored in the register selected by the multiplexer is written to the operation register. The DMA controller performs control so that DMA transfer is executed based on the data stored in the operation register.

### BACKGROUND OF THE INVENTION

1. Field of the Invention

The present invention relates to a data processing control apparatus that alternatively makes one among a plurality of service executers each designed to execute a particular kind of service such as DMA transfer execute its service. The present invention relates also to a DMA (direct memory access) controller that controls data transfer executed between peripheral devices without a detour through a CPU (central processing unit). The present invention relates further to a data processing apparatus such as a personal computer provided with such a data processing control apparatus or DMA controller.

2. Description of the Prior Art

First, as an example of a conventional data processing control apparatus, a DMA controller will be described. A DMA controller, on receiving from a peripheral device a request for data transfer, requests access to a system bus. When the DMA controller is permitted access to the system bus, it starts data transfer from a previously set source to a previously set destination. In data transfer under the control of a DMA controller (hereinafter referred to as “DMA transfer”), as opposed to in data transfer under the control of a CPU, there is no need to read and interpret commands. This permits faster data transfer.

In a DMA controller provided with a plurality of channels, at a given moment, whichever of the channels on which DMA transfer is requested is given the highest priority is permitted to execute service (DMA transfer). In some DMA controllers, to prevent a single channel from exclusively executing service, the orders of priority given to the individual channels are updated in such a way that, every time a given channel has continuously executed an amount of service that a single channel is permitted to continuously execute, that channel is given the lowest priority.

For example, in a case where there are four channels, named CH1, CH2, CH3, and CH4, respectively, when one of the channels CH1, CH2, CH3, and CH4 has continuously executed an amount of service that a single channel is permitted to continuously execute, the orders of priority of the four channels are updated as shown in FIGS. 11A, 11B, 11C, and 11D, respectively. A conventional example of this type is disclosed, for example, in Japanese Patent Application Laid-Open No. H6-83642.

However, conventionally, the amount of service that a single channel is permitted to continuously execute is fixed at a value common to all the channels. Thus, when the orders of priority of the channels are updated in the manner described above, execution of service is always distributed evenly among all those channels on which execution of service is requested. This leads to the problem described below.

For example, in a case where data transfer is requested on all the channels and, while no delay is permitted in the data transfer requested on one CH1 of the channels, a certain delay is permitted in the data transfer requested on the other channels, even though it is desirable to execute data transfer on the channel CH1 with priority, it is impossible to do so. This may lead to failure to complete the data transfer requested on the channel CH1 within the predetermined period of time allocated for it.

Moreover, with a conventional DMA controller, first, a CPU writes the conditions (the data needed to execute DMA transfer, such as the addresses of the source and destination, the amount of data transferred, etc.) under which to execute DMA transfer to an appropriate setting register, and then the DMA controller, on receiving from a peripheral device a request for data transfer, executes DMA transfer under the conditions written to the setting register. A conventional example of this type is disclosed, for example, in Japanese Patent Application Laid-Open No. H7-306825.

This makes it impossible to make settings for DMA transfer on a channel that is currently being used (i.e., a channel on which execution of already set DMA transfer has not yet been completed). Accordingly, when the CPU wants to execute DMA transfer in a given task, if all the DMA channels are being used, the CPU must wait for the end of the DMA transfer that is currently being executed. This invites task switching, which wastes the CPU's processing time.

In this way, when DMA transfer is being executed, no settings can be made for new DMA transfer until the end of the DMA transfer that is currently being executed. Thus, every time DMA transfer that is currently being executed ends, the CPU needs to receive an interrupt request indicating the end of that DMA transfer and then make settings for the next DMA transfer. Handling this interrupt request requires extra processing, such as saving of register values, and thus increases the burden on the CPU, leading to lower performance of the system as a whole.

### SUMMARY OF THE INVENTION

An object of the present invention is to provide a data processing control apparatus that prevents a single service executer from exclusively executing service and that permits a desired service executer to execute service with priority. Another object of the present invention is to provide a DMA controller with which a CPU's processing time is less wasted by task switching or the like. Still another object of the present invention is to provide a DMA controller that uses less of a CPU's processing time to make settings for DMA transfer and that thereby makes the burden on the CPU accordingly lighter.

A further object of the present invention is to provide a data processing apparatus such as a personal computer provided with a data processing control apparatus or DMA controller as described above.

To achieve the above object, according to one aspect of the present invention, a data processing control apparatus that alternatively makes one among a plurality of service executers each designed to execute a particular kind of service execute service is provided with:

a controller for performing control so that whichever of the service executers requested to execute service is given the highest order of priority executes service;

a priority updater for updating the orders of priority given to the individual service executers in such a way that, every time a given service executer has continuously executed an amount of service that a single service executer is permitted to continuously execute, the given service executer is given the lowest order of priority; and

a memory for storing, for each of the service executers, data indicating the amount of service that a single service executer is permitted to continuously execute.

With this configuration, whichever of the service executers requested to execute service is given the highest priority can start executing service. In addition, every time a given service executer has continuously executed an amount of service that a single service executer is permitted to continuously execute, that service executer is given the lowest priority. This helps avoid the problem of a single service executer exclusively executing service. Moreover, the amount of service that a single service executer is permitted to continuously execute can be set independently for each service executer. This makes it possible to make a desired service executer execute service with priority.

According to another aspect of the present invention, a DMA controller is provided with:

a setting register for permitting a CPU to make settings for DMA therein;

an operation register for permitting the data stored in the setting register to be written thereto, or an operation counter for performing counting operation by use of the data;

an operation controller for performing control so that, when DMA transfer is started, the data stored in the setting register is written to the operation register or the operation counter; and

a transfer executer for executing DMA transfer based on the data stored in the operation register or the operation counter.

With this configuration, when DMA transfer is started, the values in the setting register are written to the operation register, and DMA transfer is executed according to the values in a group of counters. Thus, by writing information needed for DMA transfer to the setting register, it is possible to make settings for DMA transfer even on a DMA channel that is currently being used. Accordingly, when DMA transfer needs to be executed, even if all the DMA channels are currently being used, it is possible to make settings for DMA transfer without waiting for the end of DMA transfer. This helps reduce the wasting of the CPU's processing time resulting from task switching and the like.

According to another aspect of the present invention, a DMA controller is provided with:

an operation register for storing the transfer conditions under which DMA transfer is currently being executed;

a setting register for storing the transfer conditions under which DMA transfer is to be executed next time;

a setting execution register for storing the transfer conditions under which to transfer, by DMA transfer, transfer conditions for DMA transfer from an external memory to the setting register;

a selector for alternatively selecting one of the setting register and the setting execution register;

a selection controller for performing control so that the register selected by the selector is switched alternately between the setting register and the setting execution register every time DMA transfer ends;

an operation register controller for performing control so that, when DMA transfer is started, data stored in the register selected by the selector is written to the operation register; and

a transfer executer for executing DMA transfer based on the data stored in the operation register.

By duplicating the conventionally provided setting register in this way, it is possible to alternately execute the operation of transferring, by DMA transfer, transfer conditions for DMA transfer from an external memory to the DMA controller and the operation of executing DMA transfer according to the transfer conditions for DMA transfer that have been transferred, by DMA transfer, from the external memory to the DMA controller Thus, the CPU can make settings for DMA transfer by writing transfer conditions for DMA transfer to an external memory. This makes it possible to make settings for a plurality of sessions of DMA transfer at a time and thereby reduce the proportion of the CPU's processing time that is used to make settings for DMA transfer.

According to the present invention, a data processing apparatus is provided with a CPU for executing a program and a memory for storing data or for storing data and the program, and the data can be read out from the memory through a data processing control apparatus or DMA controller as described above.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram of the DMA controller of a first embodiment of the invention;

FIG. 2 is a diagram showing the circuit configuration of each DMA channel shown in FIG. 1;

FIG. 3 is a flow chart illustrating the operation of the DMA start controller shown in FIG. 1;

FIG. 4 is a flow chart illustrating the operation of the channel select sequencer shown in FIG. 1;

FIG. 5 is a diagram illustrating the contents that the CPU writes to the RAM 400 when DMA transfer is executed in a reload mode;

FIG. 6 is a flow chart illustrating the operation of the DMA execution sequencer shown in FIG. 2;

FIG. 7 is a flow chart illustrating the operation of the DMA execution sequencer shown in FIG. 2;

FIG. 8 is a flow chart illustrating the operation of the register controller shown in FIG. 2;

FIG. 9 is a flow chart illustrating the operation of the register controller shown in FIG. 2;

FIG. 10 is a diagram showing an example of how execution of DMA transfer shifts from one DMA channel to another in the DMA controller of the first embodiment;

FIGS. 11A to 11D are diagrams showing how the orders of priority given to the channels are updated when a given channel has continuously executed an amount of service that a single channel is permitted to continuously execute;

FIG. 12 is a block diagram of the DMA controller of a second embodiment of the invention;

FIG. 13 is a diagram showing the circuit configuration of each DMA channel shown in FIG. 12;

FIG. 14 is a flow chart illustrating the operation of the sequencer shown in FIG. 13;

FIG. 15 is a flow chart illustrating the operation of the sequencer shown in FIG. 13;

FIG. 16 is a flow chart illustrating the operation of the register controller shown in FIG. 13;

FIG. 17 is a flow chart illustrating the operation of the register controller shown in FIG. 13;

FIG. 18 is a block diagram of the DMA controller of a third embodiment of the invention;

FIG. 19 is a diagram showing an example of the conditions for DMA transfer that are stored in the RAM 3003;

FIG. 20 is a diagram illustrating the operation of the DMA controller of the third embodiment;

FIG. 21 is a diagram showing an example of the values stored in each register in the DMA controller of the third embodiment;

FIG. 22 is a block diagram of the DMA controller of a fourth embodiment of the invention;

FIG. 23 is a diagram showing the circuit configuration of each DMA channel shown in FIG. 22;

FIG. 24 is a diagram illustrating the contents that the CPU writes to the RAM 4400 when DMA transfer is executed in a reload mode 4;

FIG. 25 is a flow chart illustrating the operation of the sequencer shown in FIG. 23;

FIG. 26 is a flow chart illustrating the operation of the sequencer shown in FIG. 23;

FIG. 27 is a flow chart illustrating the operation of the register controller shown in FIG. 23; and

FIG. 28 is a flow chart illustrating the operation of the register controller shown in FIG. 23.

### DESCRIPTION OF THE PREFERRED EMBODIMENTS

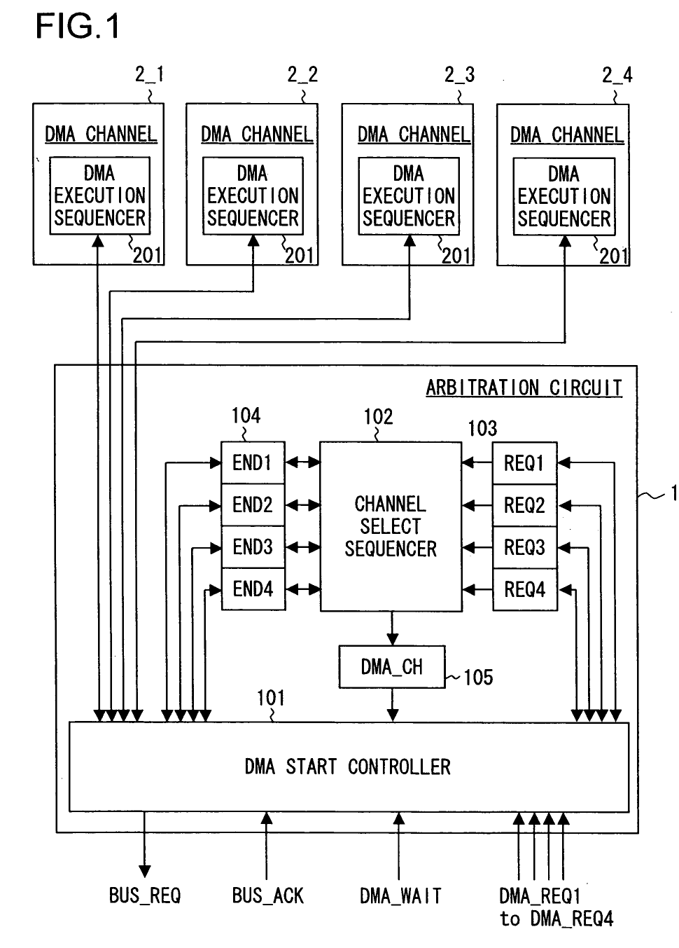

Hereinafter, embodiments of the present invention will be described with reference to the drawings. First, the DMA controller of a first embodiment of the invention will be described. FIG. 1 shows a block diagram of this DMA controller. Reference numeral 1 represents an arbitration circuit, and reference numerals 2_1, 2_2, 2_3, and 2_4 respectively represent DMA channels. The arbitration circuit 1 includes a DMA start controller 101, a channel select sequencer 102, a request register 103, an end register 104, and a start channel register 105.

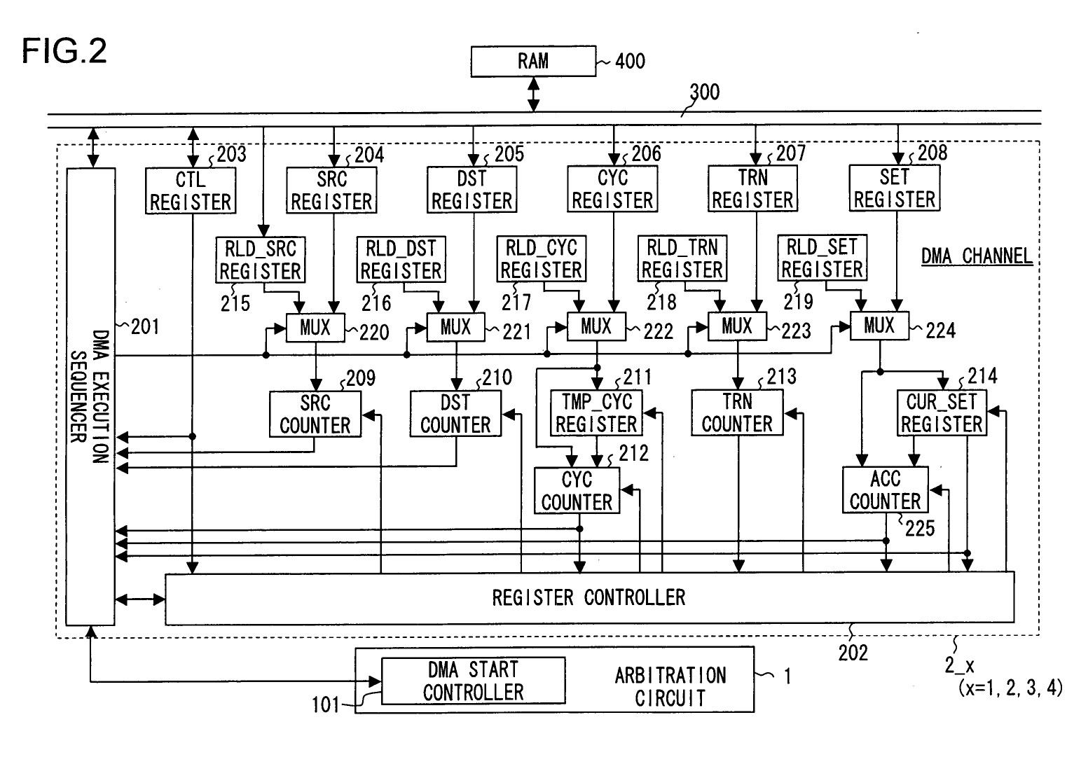

The DMA channels 2_1, 2_2, 2_3, and 2_4 each include, as shown in FIG. 2, which shows the circuit configuration thereof, a DMA execution sequencer 201, a register controller 202, a CTL register 203, a SRC register 204, a DST register 205, a CYC register 206, a TRN register 207, a SET register 208, a SRC counter 209, a DST counter 210, a TMP_CYC register 211, a CYC counter 212, a TRN counter 213, a CUR_SET register 214, an RLD_SRC register 215, an RLD_DST register 216, an RLD_CYC register 217, an RLD_TRN register 218, an RLD_SET register 219, multiplexers 220, 221, 222, 223, and 224, and an ACC counter 225.

In the arbitration circuit 1, the DMA start controller 101 arbitrates access to a system bus 300, and performs control so that alternatively one of the DMA channels 2_1, 2_2, 2_3, and 2_4 executes DMA transfer at a given time. The channel select sequencer 102 chooses on which DMA channel to execute DMA transfer according to the values in the request register 103 and the end register 104. The request register 103 is a register in which is stored data that indicates on which DMA channel DMA transfer is being requested. The end register 104 is a register to which is written data that indicates the operation status of the individual DMA channels. The start channel register 105 is a register to which is written data that indicates the DMA channel chosen by the channel select sequencer 102.

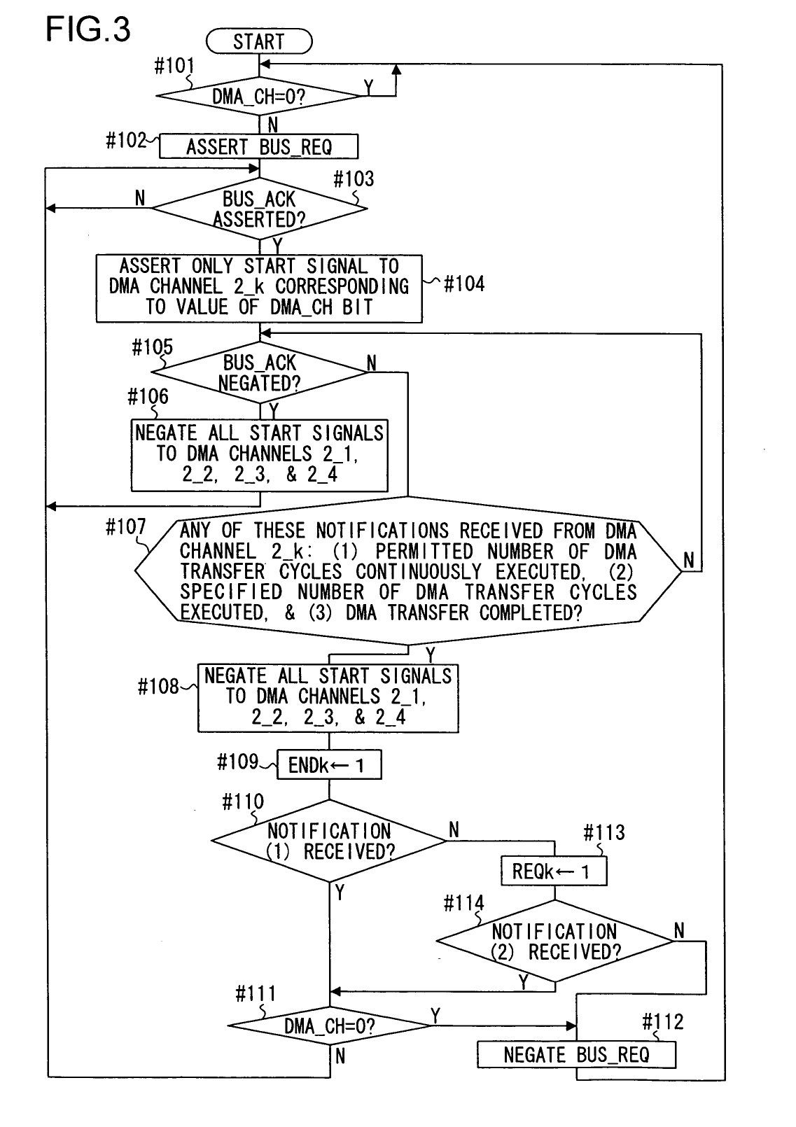

Now, the operation of the DMA start controller 101 will be described in detail with reference to the flow chart shown in FIG. 3. First, whether or not the value of DMA_CH bits of the start channel register 105 is “0” is checked (step #101). If the value of the DMA_CH bits is not “0” (“N” in #101), an output signal BUS_REQ is asserted (i.e., access to the system bus 300 is requested) (#102). Next, whether or not an input signal BUS_ACK is asserted (i.e., access to the system bus 300 is permitted) is checked (#103).

If the input signal BUS_ACK is asserted (“Y” in #103), among start signals for the DMA channels 2_1, 2_2, 2_3, and 2_4, only the one for the DMA cannel 2_{—}k (k=1, 2, 3, or 4) that corresponds to the value of the DMA_CH bits of the start channel register 105 is asserted (#104).

Specifically, in #104, if the value of the DMA_CH bits is “1,” only the start signal for the DMA channel 2_1 is asserted; if the value of the DMA_CH bits is “2,” only the start signal for the DMA channel 2_2 is asserted; if the value of the DMA_CH bits is “3,” only the start signal for the DMA channel 2_3 is asserted; if the value of the DMA_CH bits is “4,” only the start signal for the DMA channel 2_4 is asserted.

On completion of #104, whether or not the input signal BUS_ACK is negated (i.e., whether or not access to the system bus 300 is withdrawn) is checked (#105). If the BUS_ACK is negated (“Y” in #105), the start signals for the DMA channels 2_1, 2_2, 2_3, and 2_4 are all negated (#106). On completion of #106, the flow returns to #103 described above. On the other hand, if BUS_ACK is not negated (“N” in #105), the flow proceeds to #107.

In #107, whether or not one of the following notifications has been received from the DMA channel 2_{—}k is checked: a notification that DMA transfer has been continuously executed through a permitted number of cycles, a notification that DMA transfer has been executed through a specified number of cycles, and a notification that DMA transfer has been completed. If the check in #107 results in “yes” (“Y” in #107), the start signals for the DMA channels 2_1, 2_2, 2_3, and 2_4 are all negated (#108), and in addition an ENDk bit of the end register 104 is set to “1” (#109).

After #109, if the received notification is that DMA transfer has been continuously executed through a permitted number of cycles (“Y” in #110), the flow proceeds to #111 described later. On the other hand, if the received notification is not that DMA transfer has been continuously executed through a permitted number of cycles (“N” in #110), the flow proceeds to #113 described later.

In #111, whether or not the value of the DMA_CH bits of the start channel register 105 is “0” is checked. If the value of the DMA_CH bits is not “0” (“N” in #111), the flow returns to #103 described above. On the other hand, if the value of the DMA_CH bits is “0” (“Y” in #111), the output signal BUS_REQ is negated (i.e., the request for access to the system bus 300 is withdrawn) (#112). On completion of #112, the flow returns to #101 described above.

In #113, a REQk bit of the request register 103 is set to “0.” After #113, if the received notification is that DMA transfer has been executed through a specified number of cycles (“Y” in #114), the flow returns to #111 described above. On the other hand, if the received notification is not that DMA transfer has been executed through a specified number of cycles (in other words, if the received notification is that DMA transfer has been completed) (“N” in #114), the flow returns to #112 described above.

In addition to the above operations, when DMA transfer is requested on the DMA channel 2_{—}x (x=1, 2, 3, or 4) (specifically, for example, when an input signal DMA_REQx turns from a negated state to an asserted state), the DMA start controller 101 sets a REQx bit of the request register 103 to “1.”

Moreover, when a DMA wait command is issued from a bus controller (not illustrated) (specifically, when an input signal DMA_WAIT is asserted), wait signals for the DMA channels 2_1, 2_2, 2_3, and 2_4 are asserted. When the DMA wait command is canceled (specifically, when the input signal DMA_WAIT is negated), those wait signals are negated.

Incidentally, the bus controller controls the signal DMA_WAIT according to the address that the DMA controller has accessed so that the DMA controller does not proceed to the next operation before completing the reading or writing of data at the address that it has accessed.

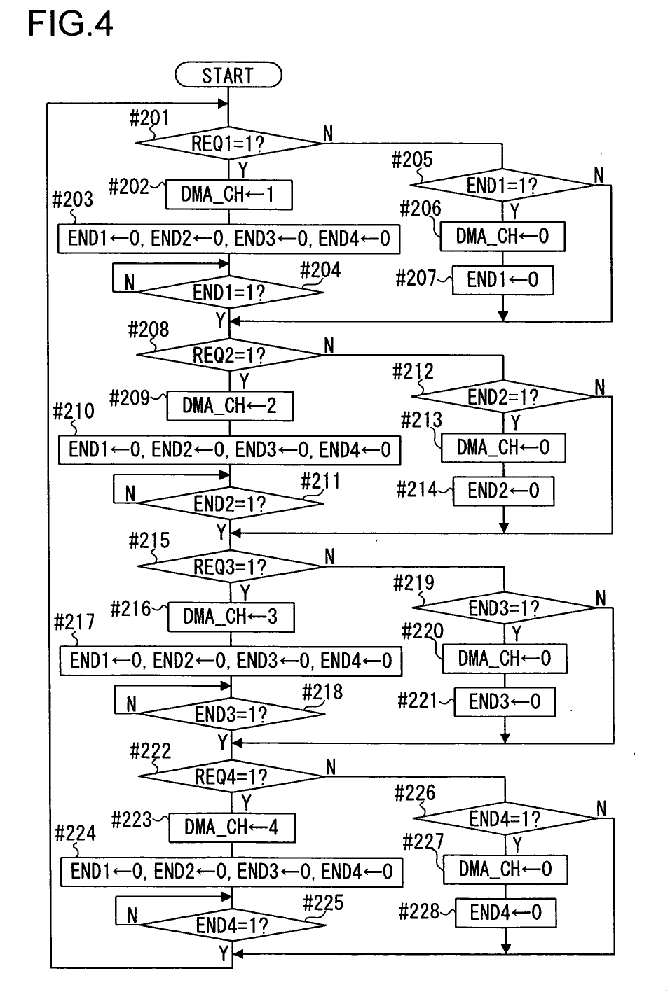

Now, the operation of the channel select sequencer 102 will be described in detail with reference to the flow chart shown in FIG. 4. First, whether or not a REQ1 bit of the request register 103 is “1” is checked (#201). If the REQ1 bit is “1” (“Y” in #201), the value of the DMA_CH bits of the start channel register 105 is set to “1” (#202), and in addition END1, END2, END3, and END4 bits of the end register 104 are set to “0” (#203). Thereafter, when the END1 bit turns to “1” (“Y” in #204), the flow proceeds to #208 described later.

On the other hand, if the REQ1 bit is not “1” (“N” in #201), whether or not the END1 bit of the end register 104 is “1” is checked (#205). If the END1 bit is “1” (“Y” in #205), the value of the DMA_CH bits of the start channel register 105 is set to “0” (#206), and in addition the END1 bit is set to “0” (#207). Thereafter, the flow proceeds to #208. On the other hand, if the END1 bit is not “1” (“N” in #205), the flow proceeds directly to #208.

In #208, whether or not a REQ2 bit of the request register 103 is “1” is checked. If the REQ2 bit is “1” (“Y” in #208), the value of the DMA_CH bits of the start channel register 105 is set to “2” (#209), and in addition the END1, END2, END3, and END4 bits of the end register 104 are set to “0” (#210). Thereafter, when the END2 bit turns to “1” (“Y” in #211), the flow proceeds to #215 described later.

On the other hand, if the REQ2 bit is not “1” (“N” in #208), whether or not the END2 bit of the end register 104 is “1” is checked (#212). If the END2 bit is “1” (“Y” in #212), the value of the DMA_CH bits of the start channel register 105 is set to “0” (#213), and in addition the END2 bit is set to “0” (#214). Thereafter, the flow proceeds to #215. On the other hand, if the END2 bit is not “1” (“N” in #212), the flow proceeds directly to #215.

In #215, whether or not a REQ3 bit of the request register 103 is “1” is checked. If the REQ3 bit is “1” (“Y” in #215), the value of the DMA_CH bits of the start channel register 105 is set to “3” (#216), and in addition the END1, END2, END3, and END4 bits of the end register 104 are set to “0” (#217). Thereafter, when the END3 bit turns to “1” (“Y” in #218), the flow proceeds to #222 described later.

On the other hand, if the REQ3 bit is not “1” (“N” in #215), whether or not the END3 bit of the end register 104 is “1” is checked (#219). If the END3 bit is “1” (“Y” in #219), the value of the DMA_CH bits of the start channel register 105 is set to “0” (#220), and in addition the END3 bit is set to “0” (#220). Thereafter, the flow proceeds to #222. On the other hand, if the END3 bit is not “1” (“N” in #219), the flow proceeds directly to #222.

In #222, whether or not a REQ4 bit of the request register 103 is “1” is checked. If the REQ4 bit is “1” (“Y” in #222), the value of the DMA_CH bits of the start channel register 105 is set to “4” (#223), and in addition the END1, END2, END3, and END4 bits of the end register 104 are set to “0” (#224). Thereafter, when the END4 bit turns to “1” (“Y” in #225), the flow returns to #201 described above.

On the other hand, if the REQ4 bit is not “1” (“N” in #222), whether or not the END4 bit of the end register 104 is “1” is checked (#226). If the END4 bit is “1” (“Y” in #226), the value of the DMA_CH bits of the start channel register 105 is set to “0” (#227), and in addition the END4 bit is set to “0” (#228). Thereafter, the flow returns to #201 described above. On the other hand, if the END4 bit is not “1” (“N” in #226), the flow returns directly to 201 described above.

Incidentally, registers are initialized at start-up. Specifically, the REQ1, REQ2, REG3, and REQ4 bits of the request register 103 are each set to “0,” the END1, END2, END3, and END4 bits of the end register 104 are each set to “0,” and the value of the DMA_CH bits of the start channel register 105 is set to “0.”

In each of the DMA channels 2_1, 2_2, 2_3, and 2_4, under the control of the arbitration circuit 1, and according to the contents of the CTL register 203, SRC counter 209, DST counter 210, CYC counter 212, CUR_SET register 214, ACC counter 225, and the register (not illustrated) provided within the register controller 202, the DMA execution sequencer 201 executes DMA transfer.

According to instructions from the DMA execution sequencer 201 and according to the contents of the CTL register 203, CYC counter 212, TRN counter 213, CUR_SET register 214, ACC counter 225, and the register provided within the register controller 202, the register controller 202 controls the operation of the SRC counter 209, DST counter 210, TMP_CYC register 211, CYC counter 212, TRN counter 213, CUR_SET register 214, and ACC counter 225, and also rewrites the register provided within the register controller 202. The register provided within the register controller 202 includes an EOP_O bit that indicates whether or not DMA transfer has been completed.

A CPU writes information needed to execute DMA transfer to the CTL register 203, SRC register 204, DST register 205, CYC register 206, TRN register 207, and SET register 208.

Specifically, the CTL register 203 includes an ENB bit that indicates whether or not execution of DMA transfer is permitted, a RESUM bit that indicates whether or not DMA transfer is interrupted, MOD1 and MOD0 bits that indicate operation modes, a S/W_START bit that permits DMA transfer to be started by software, a CEPE bit that indicates whether or not to notify the CPU of the end of DMA transfer by means of an interrupt signal, an NEPE bit that indicates whether or not to notify the CPU of the end of the next DMA transfer by means of an interrupt signal, and other bits. Thus, information needed to control DMA transfer is written to the CTL register 203. To the SRC register 204 is written the start address of the data source area (the area from which data is read). To the DST register 205 is written the start address of the data destination area (the area to which data is written).

To the CYC register 206 is written a value that is commensurate with the number of cycles involved in one DMA transfer session (here, one cycle consists of one read operation and one write operation). To the TRN register 207 is written a value that is commensurate with the number of DMA transfer sessions executed. To the SET register 208 is written other information relating to DMA transfer (for example, the size of data transferred in one cycle, whether or not to update the source and destination addresses every cycle, etc.).

The SET register 208 includes CR bits, to which the CPU writes data that indicates through how many cycles the relevant DMA channel is permitted to continuously execute DMA transfer (specifically, in the form of a value equal to the permitted number of cycles minus one). The CUR_SET register 214 and the RLD_SET register 219 each also include CR bits.

The SRC counter 209 is a counter in which the address of the source is stored and that is updated whenever necessary. The DST counter 210 is a counter in which the address of the destination is stored and that is updated whenever necessary. The TMP_CYC register 211 is a register in which is stored the number of cycles to be executed in one DMA transfer session. The CYC counter 212 is a counter that counts the number of cycles that have been executed in one DMA transfer session. The TRN counter 213 is a counter that counts the number of DMA transfer sessions that have been executed. The CUR_SET register 214 is a register in which is stored the information written to the SET register 208. The ACC counter 225 is a counter that counts the number of cycles that have been continuously executed on the relevant DMA channel.

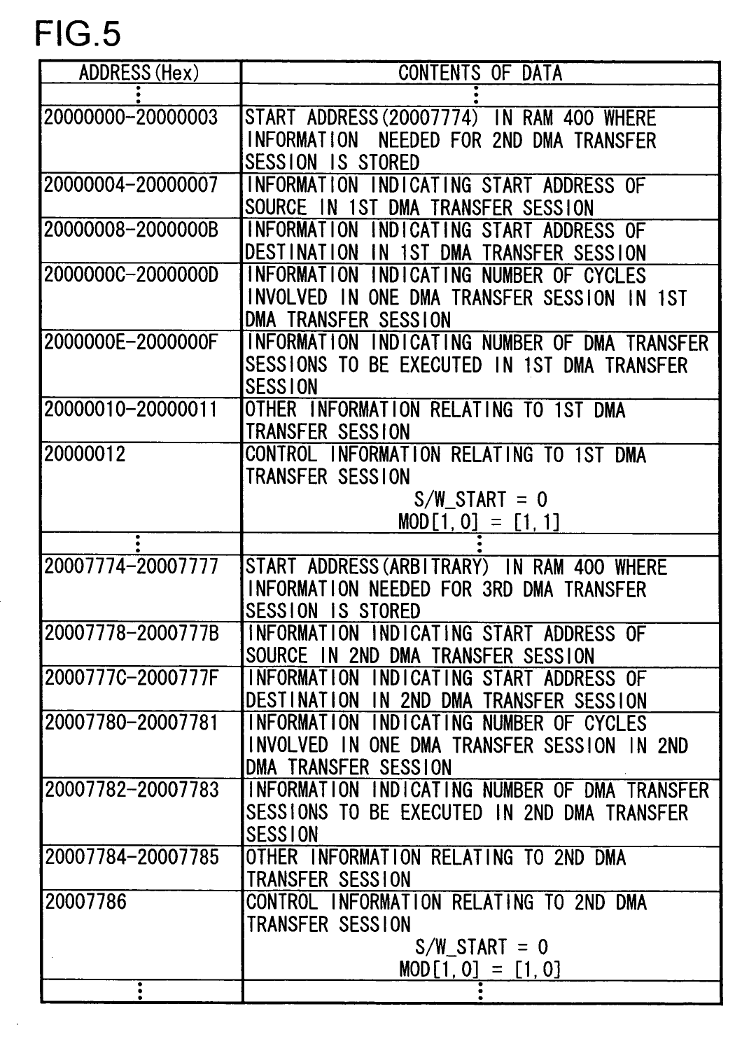

As will be described later, the DMA controller of this embodiment has a mode (called the reload mode) in which, when DMA transfer is executed, the information needed to do that is transferred by DMA transfer from a RAM 400 to the DMA controller itself. When the CPU makes the DMA controller execute DMA transfer in this reload mode, as an example is shown in FIG. 5, the CPU writes, for each DMA transfer session to be executed, the start address in the RAM 400 where the information needed to execute DMA transfer next time is written and the information itself needed to execute DMA transfer this time (information indicating the start address of the source, information indicating the start address of the destination, information indicating the number of cycles to be executed in one DMA transfer session, information indicating the number of DMA transfer sessions to be executed, other information, and control information) to a contiguous area in the RAM 400. In the example shown in FIG. 5, two DMA transfer sessions have been set.

The RLD_SRC register 215 is a register to which the CPU writes the start address in the RAM 400 where the information needed for DMA transfer is written. The RLD_DST register 216, RLD_CYC register 217, RLD_TRN register 218, and RLD_SET register 219 are registers to which is written the information necessary to transfer by DMA transfer from the RAM 400 to the group of registers of the relevant DMA channel (the SRC register 204, DST register 205, CYC register 206, TRN register 207, and SET register 208) the information necessary to execute DMA transfer.

The multiplexer 220 chooses either the data held in the SRC register 204 or the data held in the RLD_SRC register 215 according to an instruction from the DMA execution sequencer 201. The data chosen by the multiplexer 220 is fed to the SRC counter 209.

The multiplexer 221 chooses either the data held in the DST register 205 or the data held in the RLD_DST register 216 according to an instruction from the DMA execution sequencer 201. The data chosen by the multiplexer 221 is fed to the DST counter 210.

The multiplexer 222 chooses either the data held in the CYC register 206 or the data held in the RLD_CYC register 217 according to an instruction from the DMA execution sequencer 201. The data chosen by the multiplexer 222 is fed to the TMP_CYC register 211 and the CYC counter 212. To the CYC counter 212 is also fed the data held in the TMP_CYC register 211.

The multiplexer 223 chooses either the data held in the TRN register 207 or the data held in the RLD_TRN register 218 according to an instruction from the DMA execution sequencer 201. The data chosen by the multiplexer 223 is fed to the TRN counter 213.

The multiplexer 224 chooses either the data held in the SET register 208 or the data held in the RLD_SET register 219 according to an instruction from the DMA execution sequencer 201. The data chosen by the multiplexer 224 is fed to the CUR_SET register 214 and the ACC counter 225. To the ACC counter 225 is fed only the data of the CR bits out of the data chosen by the multiplexer 224. Moreover, to the ACC counter 225 is also fed the data of the CR bits out of the data held in the CUR_SET register 214.

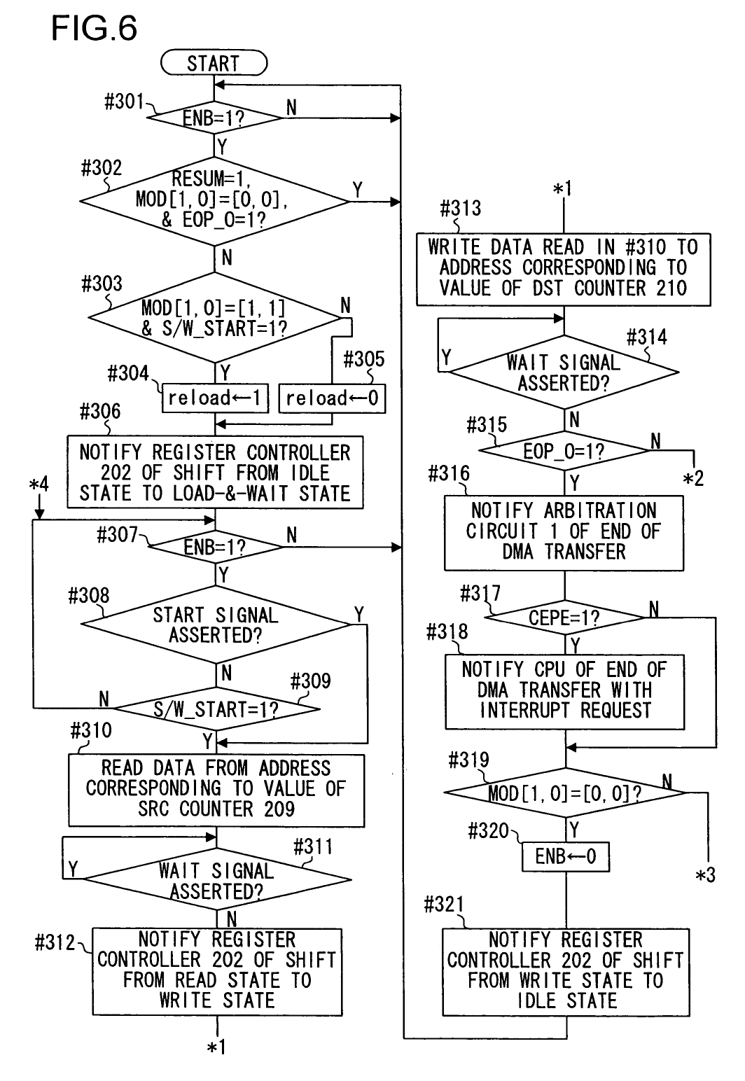

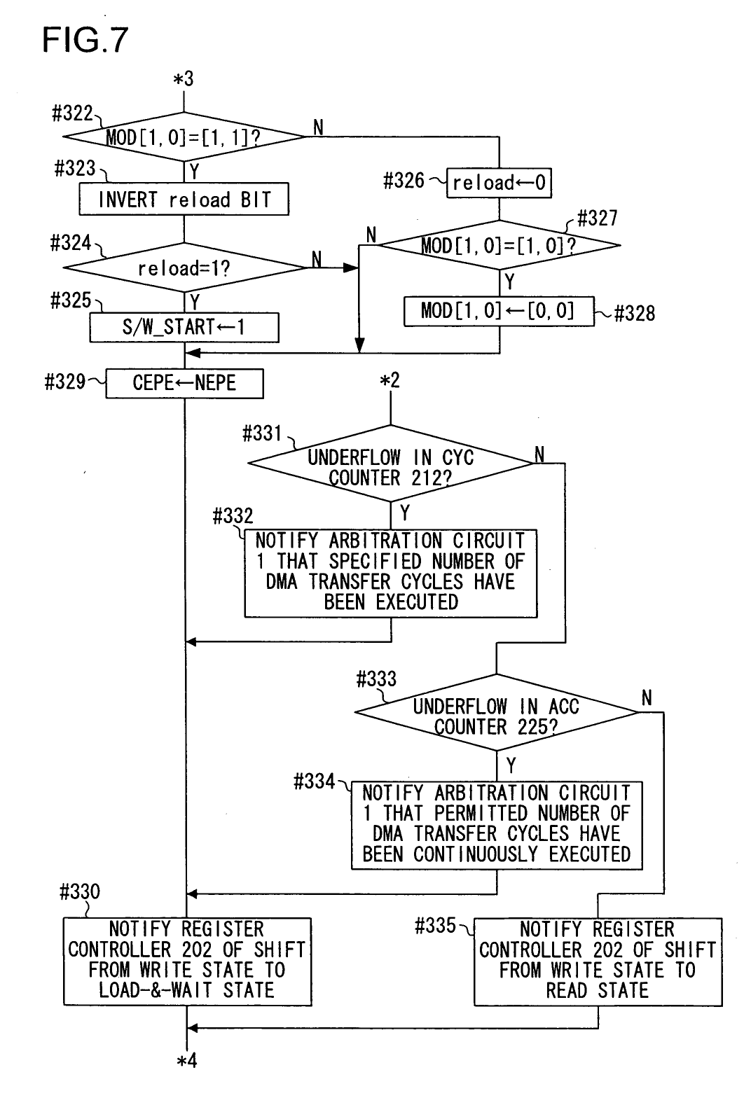

Now, the operation of the DMA execution sequencer 201 of a DMA channel will be described with reference to the flow charts shown in FIGS. 6 and 7. First, whether or not the ENB bit of the CTL register 203 is “1” is checked (#301). If the ENB bit is “1” (“Y” in #301), the flow proceeds to #302. The ENB bit of the CTL register 203 is a bit that indicates whether or not DMA transfer is permitted, and a “1” in this bit indicates that DMA transfer is permitted.

Incidentally, when the CPU completes making settings for DMA transfer on a DMA channel that is not currently being used, that is, when the CPU completes writing information necessary for DMA transfer to the CTL register 203, SRC register 204, DST register 205, CYC register 206, TRN register 207, and SET register 208, it sets the ENB bit of the CTL register 203 to “1.”

In #302, whether or not the RESUM bit, MOD1 bit, and MOD0 bit of the CTL register 203 are “1,” “0” and “0,” respectively and in addition the EOP_O bit of the register provided within the register controller 202 is “1” is checked. If the check in #302 results in “yes” (“Y” in #302), the flow returns to #301 described above; on the other hand, if it results in “no” (“N” in #302), the flow proceeds to #303.

Incidentally, the CPU, after it has interrupted DMA transfer by setting the ENB bit of the CTL register 203 to “0,” sets the RESUM bit of the CTL register 203 to “1” prior to restarting DMA transfer by setting the ENB bit to “1.” That is, the RESUM bit of the CTL register 203 is a bit that indicates whether or not DMA transfer has been interrupted or not, and a “1” in this bit indicates that DMA transfer has been interrupted.

The MOD1 and MOD0 bits of the CTL register 203 are bits that specify the mode in which DMA transfer is executed. The EOP_O bit of the register provided within the register controller 202 is a bit that indicates whether or not DMA transfer has been completed, and a “1” in this bit indicates that DMA transfer has been completed

In #303, whether or not S/W_START bit of the CTL register 203 is “1” and in addition the MOD1 and MOD0 bits are both “1” is checked. If the check in #303 results in “yes” (“Y” in #303), a reload bit of the CTL register 203 is set to “1” (#304), and then the flow proceeds to #306. On the other hand, if the check in #303 results in “no” (“N” in #303), the reload bit is set to “0” (#305), and then the flow proceeds to #306.

Incidentally, the multiplexers 220, 221, 222, 223, and 224 change their choices according to the reload bit. Specifically, when the reload bit is “0,” the multiplexers 220, 221, 222, 223, and 224 choose the data stored in the SRC register 204, DST register 205, CYC register 206, TRN register 207, and SET register 208, respectively; on the other hand, when the reload bit is “1,” the multiplexers choose the data stored in the RLD_SRC register 215, RLD_DST register 216, RLD_CYC register 217, RLD_TRN register 218, and RLD_SET register 219, respectively.

In #306, the register controller 202 is notified of a shift from an idle state to a load-and-wait state. On completion of #306, whether or not the ENB bit of the CTL register 203 is “1” is checked (#307). If the ENB bit is “1”, (“Y” in #307), the flow proceeds to #308; on the other hand, if ENB bit is not “1”, (“N” in #307), the flow returns to #301 described above.

In #308, whether or not the start signal from the arbitration circuit 1 is asserted is checked. If the start signal is asserted (“Y” in #308), the flow proceeds to #310 described later; on the other hand, if the start signal is not asserted (“N” in #308), the flow proceeds to #309.

In #309, whether or not the S/W_START bit of the CTL register 203 is “1” is checked. If the S/W_START bit is “1”, (“Y” in #309), the flow proceeds to #310 described later; on the other hand, if the S/W_START bit is not “1”, (“N” in #309), the flow proceeds to #307 described above.

In #310, the data at the address corresponding to the value of the SRC counter 209 is read to a buffer of the DMA execution sequencer 201 itself. On completion of #310, whether or not the wait signal from the arbitration circuit 1 is asserted is checked (#311). If the wait signal is not asserted (“N” in #311), the flow proceeds to #312.

In #312, the register controller 202 is notified of a shift from a read state to a write state. On completion of #312, the data read in #310 is written to the address corresponding to the value of the DST counter 210 (#313). Next, whether or not the wait signal is asserted is checked (#314), and, if the wait signal is not asserted (“N” in #314), the flow proceeds to #315.

In #315, whether or not the EOP_O bit of the register provided within the register controller 202 is “1” is checked. If the EOP_O bit is “1”, (“Y” in #315), the arbitration circuit 1 is notified of the end of DMA transfer (#316); on the other hand, if the EOP_O bit is not “1,” (“N” in #315), the flow proceeds to #331 described later.

On completion of #316, whether or not the CEPE bit of the CTL register 203 is “1” is checked (#317). If the CEPE bit is “1” (“Y” in #317), the CPU is notified, by means of an interrupt signal, that DMA transfer has been completed (#318), and then the flow proceeds to #319. On the other hand, if the CEPE bit is not “1” (“N” in #317), the flow skips #318 and proceeds directly to #319.

In #319, whether or not the MOD1 and MOD0 bits of the CTL register 203 are both “0” is checked. If the check in #319 results in “yes” (“Y” in #319), the ENB bit of the CTL register 203 is set to “0” (#320), and in addition the register controller 202 is notified of a shift from a write state to an idle state (#321). On completion of #321, the flow proceeds to #301 described above. On the other hand, if the check in #319 results in “no” (“N” in #319), the flow proceeds to #322.

In #322, whether or not the MOD1 and MOD0 bits of the CTL register 203 are both “1” is checked. If the cheek in #322 results in “yes” (“Y” in #322), the flow proceeds to #323; on the other hand, if the check in #322 results in “no” (“N” in #322), the flow proceeds to #326 described later.

In #323, the reload bit of the CTL register 203 is inverted. On completion of #323, whether or not the reload bit is “1” is checked (#324). If the reload bit is “1” (“Y” in #324), the S/W_START bit of the CTL register 203 is set to “1” (#325), and then the flow proceeds to #329 described later. On the other hand, if the reload bit is not “1” (“N” in #324), the flow skips #325 and proceeds directly to #329 described later.

In #326, to which the flow proceeds if the check in #322 results in “no” (“N” #322), the reload bit of the CTL register 203 is set to “0.” On completion of #326, whether or not the MOD1 and MOD0 bits of the CTL register 203 are “1” and “0,” respectively, is checked (#327).

If the check in #327 results in “yes” (“Y” in #327), the MOD1 and MOD0 bits are both set to “0” (#328), and then the flow proceeds to #329. On the other hand, if the check in #327 results in “no” (“N” in #327), the flow skips #328 and proceeds directly to #329.

In #329, the value of the CEPE bit of the CTL register 203 is updated with the value of the NEPE bit of the CTL register 203. On completion of #329, the register controller 202 is notified of a shift from a write state to a load-and-wait state (#330). On completion of #330, the flow returns to #307 described above.

In #331, to which the flow proceeds if the check in #315 results in “no” (“N” in #315), whether or not an underflow is occurring in the CYC counter 212 is checked. If an underflow is occurring in the CYC counter 212 (“Y” in #331), the arbitration circuit 1 is notified that the specified number of DMA transfer cycles have been executed (#332). After #332, the flow returns to #330 described above. On the other hand, if no underflow is occurring in the CYC counter 212 (“N” in #331), the flow proceeds to #333.

In #333, whether or not an underflow is occurring in the ACC counter 225 is checked. If an underflow is occurring in the ACC counter 225 (“Y” in #333), the arbitration circuit 1 is notified that the permitted number of DMA transfer cycles have continuously been executed (#334). After #334, the flow returns to #330 described above. On the other hand, if no underflow is occurring in the ACC counter 225 (“N” in #333), the register controller 202 is notified of a shift from a write state to a read state (#335). On completion of #335, the flow returns to #307 described above.

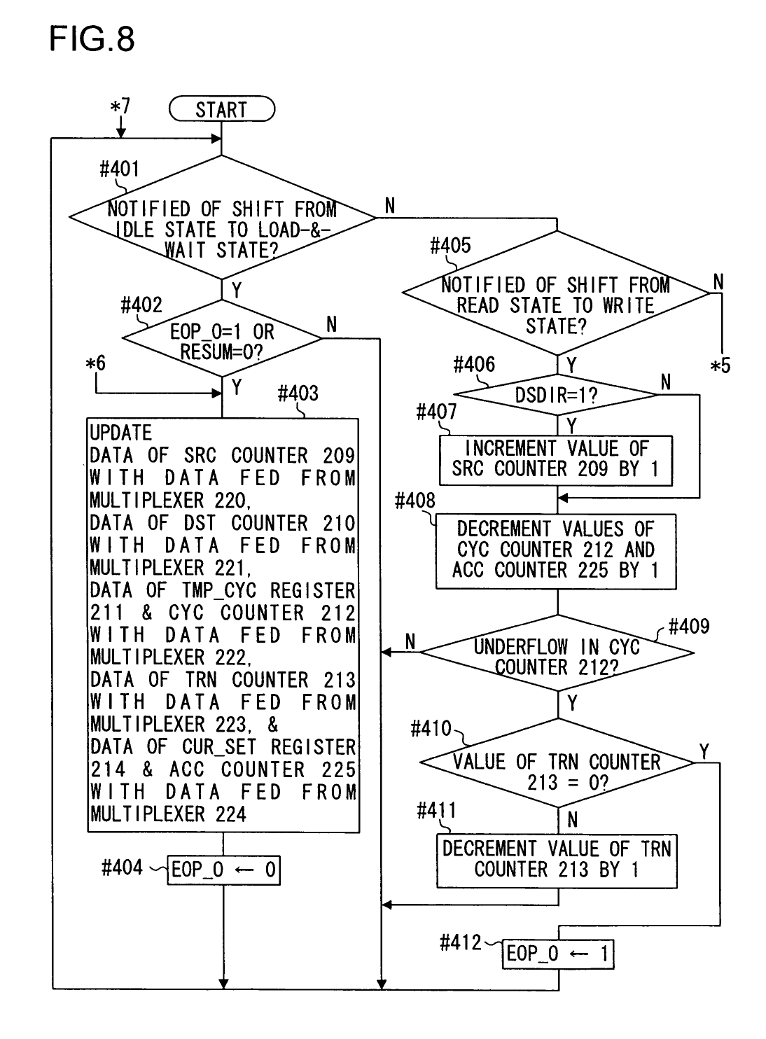

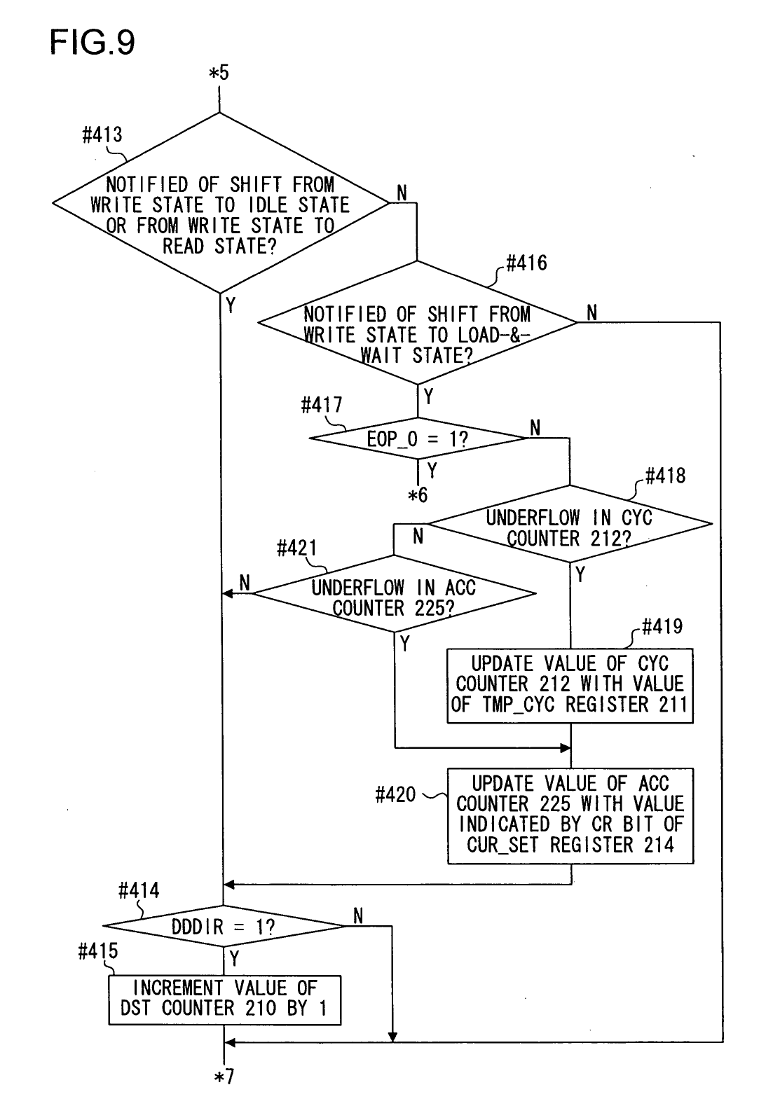

Now, the operation of the register controller 202 will be described with reference to the flow charts shown in FIGS. 8 and 9. The register controller 202 monitors notifications of shifts in status from the DMA execution sequencer 201 (#401, #405, #413, and #416).

First, a description will be given of a case where the register controller 202 is notified, from the DMA execution sequencer 201, of a shift from an idle state to a load-and-wait state. In this case, the check in #401 results in “yes” (“Y” in #401), and whether or not the EOP_O bit of the register provided within the register controller 202 itself is “1,” or whether or not the RESUM bit of the CTL register 203 is “0,” is checked (#402).

If the check in #402 results in “yes” (“Y” in #402), the data of the SRC counter 209 is updated with the data fed from the multiplexer 220, the data of the DST counter 210 is updated with the data fed from the multiplexer 221, the data of the TMP_CYC register 211 and the CYC counter 212 is updated with the data fed from the multiplexer 222, the data of the TRN counter 213 is updated with the data fed from the multiplexer 223, the data of the CUR_SET register 214 and the ACC counter 225 is updated with the data fed from the multiplexer 224 (#403). In addition, the EOP_O bit of the register provided within the register controller 202 itself is set to “0” (#404).

Next, a description will be given of a case where the register controller 202 is notified, from the DMA execution sequencer 201, of a shift from a read state to a write state. In this case, the check in #405 results in “yes” (“Y” in #405), and whether or not a DSDIR bit of the CUR_SET register 214 is “1” is checked (#406).

If the DSDIR bit is “1” (“Y” in #406”), the value of the SRC counter 209 is incremented by one (#407), and then the flow proceeds to #408. On the other hand, if the DSDIR bit is not “1” (“N” in #406), the flow skips #407 and proceeds directly to #408.

In #408, the values of the CYC counter 212 and the ACC counter 225 are decremented by one. On completion of #408, whether or not an underflow is occurring in the CYC counter 212 is checked (#409). If an underflow is occurring in the CYC counter 212 (“Y” in #409), whether or not the value of the TRN counter 213 is “0” is checked (#410).

If the value of the TRN counter 213 is not “0” (“N” in #410), the value of the TRN counter 213 is decremented by one (#411). On the other hand, if the value of the TRN counter 213 is “0” (“Y” in #410), the EOP_O bit of the register provided within the register controller 202 itself is set to “1” (#412).

Next, a description will be given of a case where the register controller 202 is notified, from the DMA execution sequencer 201, of a shift from a write state to an idle state or a shift from a write state to a read state. In this case, the check in #413 results in “yes” (“Y” in #413), and whether or not a DDDIR bit of the CUR_SET register 214 is “1” is checked (#414). If the DDDIR bit is “1” (“Y” in #414), the value of the DST counter 210 is incremented by one (#415).

Next, a description will be given of a case where the register controller 202 is notified, from the DMA execution sequencer 201, of a shift from a write state to a load-and-wait state. In this case, the check in #416 results in “yes” (“Y” in #416), and whether or not the EOP_O bit of the register provided within the register controller 202 itself is “1” is checked (#417).

If the EOP_O bit is “1” (“Y” in #417), #403 and #404 described above are executed. On the other hand, if the EOP_O bit is not “1” (“N” in #417), whether or not an underflow is occurring in the CYC counter 212 is checked (#418).

If an underflow is occurring in the CYC counter 212 (“Y” in #418), the value of the CYC counter 212 is updated with the value of the TMP_CYC register 211 (#419), and in addition the value of the ACC counter 225 is updated with the value indicated by the CR bits of the CUR_SET register 214 (#420). On completion of #420, the flow returns to #414 described above. On the other hand, if no underflow is occurring in the CYC counter 212 (“N” in #418), the flow proceeds to #421.

In #421, whether or not an underflow is occurring in the ACC counter 225 is checked (#421). If an underflow is occurring in the ACC counter 225 (“Y” #421), the flow returns to #420 described above. On the other hand, if no underflow is occurring in the ACC counter 225 (“N” in #421), the flow returns to #414 described above.

As the result of the DMA start controller 101 and the channel select sequencer 102 of the arbitration circuit 1 and the DMA execution sequencer 201 and the register controller 202 of each of the DMA channels 2_1, 2_2, 2_3, and 2_4 operating as described above, whichever of the DMA channels on which DMA transfer is requested is given the highest priority executes DMA transfer, but, every time a given service executer has continuously performed a permitted number of DMA transfer cycles, that service executer is given the lowest priority.

The number of DMA transfer cycles that each of the DMA channels 2_1, 2_2, 2_3, and 2_4 is permitted to continuously execute is determined by the value of the CR bits of the CUR_SET register 214 (specifically, the number is equal to the value of the CR bits of the CUR_SET register 214 pulse one). Thus, the CPU can set, independently for each of the DMA channels 2_1, 2_2, 2_3, and 2_4, the number of DMA transfer cycles that a single DMA channel is permitted to continuously execute. By setting a given DMA channel to be permitted to continuously execute a larger number of DMA transfer cycles than the other DMA channels, it is possible to make that DMA channel execute DMA transfer with priority.

In this way, it is possible to prevent a single DMA channel from exclusively executing DMA transfer, and in addition to permit a desired DMA channel to execute DMA transfer with priority.

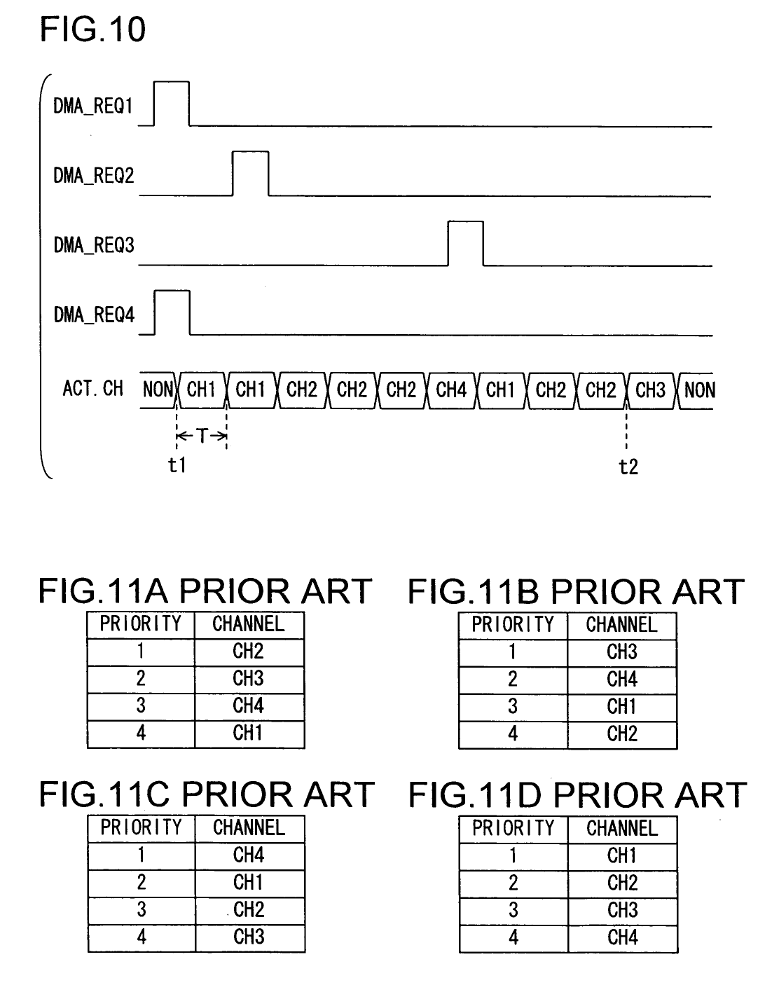

For example, suppose that the values of the CYC counter 212, TRN counter 213, and CUR_SET register 214 are respectively “2,” “0,” and “1” in the DMA channel 2_1; “4,” “0,” and “2” in the DMA channel 2_2; “0,” “0,” and “0” in the DMA channel 2_3; and “0,” “0,” and “0” in the DMA channel 2_4. Then, if the input signals DMA_REQ1, DMA_REQ2, DMA_REQ3, and DMA_REQ4 behave as shown in FIG. 10, the DMA channel on which DMA transfer is executed (ACT.CH) shifts from one DMA channel to another as shown in the same figure.

Incidentally, in FIG. 10, T represents the period of one cycle; CH1, CH2, CH3, and CH4 represent the DMA channels 2_1, 2_2, 2_3, and 2_4, respectively; and NON indicates that none of the DMA channels 2_1, 2_2, 2_3, and 2_4 is executing DMA transfer. Moreover, in FIG. 10, it is assumed that access to the system bus 300 is not withdrawn in the period between t1 and t2 shown in the figure.

In each of the DMA channels 2_1, 2_2, 2_3, and 2_4, before DMA transfer is started, the values of the group of setting registers (the SRC register 204, DST register 205, CYC register 206, TRN register 207, and SET register 208) are written to the group of operation registers (the SRC counter 209, DST counter 210, TMP_CYC register 211, CYC counter 212, TRN counter 213, CUR_SET register 214, and ACC counter 225), and DMA transfer is executed according to the values of the group of operation registers.

Thus, by writing information needed for DMA transfer to the group of setting registers, it is possible to make settings for DMA transfer even on a DMA channel that is currently being used. Accordingly, when DMA transfer needs to be executed in a given task, even when all the DMA channels are currently being used, it is possible to make settings for DMA transfer without waiting for the end of DMA transfer. This helps reduce the wasting of the CPU's processing time resulting from task switching and the like.

According to the MOD1 and MOD0 bits of the CTL register 203, a DMA channel operates in different modes as described below. On completion of DMA transfer, if the MOD1 and MOD0 bits are both set to “0,” the DMA channel goes into an idle state (in which DMA transfer is inhibited) (hereinafter referred to as the “normal mode”).

On completion of DMA transfer, if the MOD1 and MOD0 bits are set to “0” and “1,” respectively, the DMA channel goes into a load-and-wait state (in which the DMA channel, having updated the values of the group of operation registers with those of the group of setting registers, is waiting for a request for DMA transfer). Thus, the next DMA transfer is started without intervention of the CPU (hereinafter referred to as the “autorepeat mode”).

On completion of DMA transfer, if the MOD1 and MOD0 bits are set to “1” and “0,” respectively, the DMA channel sets both the MOD1 and MOD0 bits to “0” and then goes into a load-and-wait state. Thus, the next DMA transfer is started without intervention of the CPU, and then, on completion of this DMA transfer, the DMA channel goes into an idle state (hereinafter referred to as the “autostart mode”).

Accordingly, the CPU has only to rewrite the MOD1 and MOD0 bits of the CTL register 203 to make the individual DMA channels change their operation mode in such a way that: when settings for DMA transfer are made on a DMA channel that is not currently being used, the DMA channel operates in the normal mode; when DMA transfer needs to be executed repeatedly with the same settings, the relevant DMA channel operates in the autorepeat mode; and, when settings for DMA transfer are made on a DMA channel that is currently being used, the DMA channel operates in the autostart mode.

When execution of DMA transfer becomes permitted (i.e., when the ENB bit of the CTL register 203 is set to “1”), if the S/W_START, MOD1, and MOD0 bits of the CTL register 203 are all “1,” the information needed to transfer by DMA transfer from the RAM 400 to the group of setting registers the information needed for DMA transfer is read from a group of setting execution registers (the RLD_SRC register 215, RLD_DST register 216, RLD_CYC register 217, RLD_TRN register 218, and RLD_SET register 219) to the group of operation registers, and then, according to the values of the group of operation registers, DMA transfer is executed. Thus, the information needed for DMA transfer is transferred by DMA transfer from the RAM 400 to the group of setting registers. Thereafter, while the MOD1 and MOD0 bits are both “1,” the operation of transferring, by DMA transfer, the information needed for DMA transfer from the RAM 400 to the group of setting register and the operation of executing DMA transfer according to the information transferred, by DMA transfer, from the RAM 400 to the group of setting registers are executed alternately (hereinafter referred to as the “reload mode”).

In this reload mode, all that needs to be performed to execute all desired DMA transfer sessions is to write the information needed for the individual DMA transfer sessions to the RAM 400 as an example is shown in FIG. 5, then set the S/W_START, MOD1, and MOD0 bits of the CTL register 203 all to “1,” then write to the RLD_SRC register 215 the start address (in the example shown in FIG. 5, 20000000H) in the RAM 400 where the information relating to the first DMA transfer session is stored, and then set the ENB bit of the CTL register 203 to “1.” Thus, settings for a plurality of DMA transfer sessions can be made at a time.

Accordingly, when the CPU wants to set the DMA channels for a plurality of DMA transfer sessions, it can use the reload mode and thereby reduce the processing time used to make settings for DMA transfer.

On completion of DMA transfer, if the CEPE bit of the CTL register 203 is “0,” no interrupt request is sent to the CPU to notify it of the end of DMA transfer. Thus, when the CPU has made settings for the next DMA transfer, so long as the CEPE bit is set to “0,” the CPU does not receive an interrupt request from the DMA controller even at the end of the immediately previously set DMA transfer. This helps eliminate meaningless interrupt requests from the DMA controller and thereby save more time for other operations.

When the CPU has access to the system bus 300, it can rewrite the values of the CTL register 203 at any time to switch the operation mode of the DMA channels and whether or not to send an interrupt request on completion of DMA transfer. This makes it possible to flexibly cope with varying situations.

Let the value set in the CYC register 206 be p, and let the value set in the TRN register 207 be q. Then, every time DMA transfer is requested, (p+1) DMA transfer cycles are executed, and thereafter a stand-by state prevails until a new request for DMA transfer occurs. Eventually, when DMA transfer is completed in response to the (q+1)th request for DMA transfer, the entire operation is ended. That is, (q+1) DMA transfer sessions each consisting of (p+1) cycles are executed.

Accordingly, when the CPU wants to execute B DMA transfer sessions each consisting of A cycles, it has only to set, only once, the values of the CYC register 206 and the TRN resistor to A−1 and B−1, respectively. This helps reduce the burden on the CPU, and thus helps alleviate the lowering of system performance.

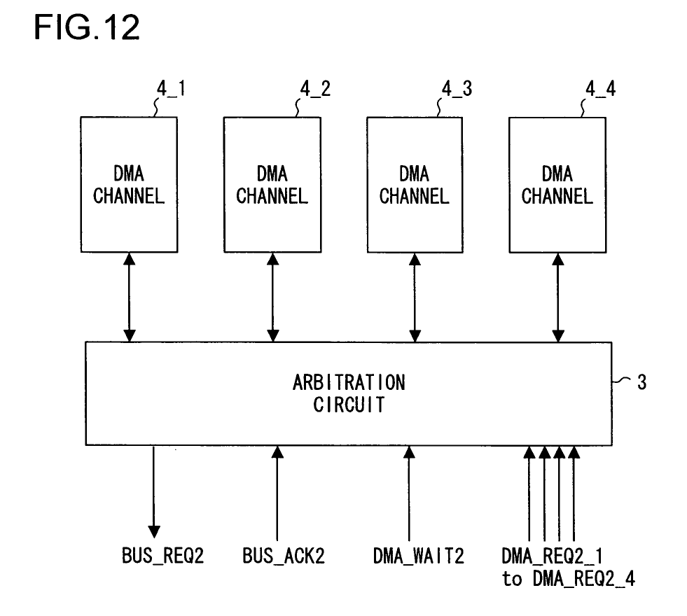

Next, the DMA controller of a second embodiment of the invention will be described. The DMA controller of the second embodiment includes, as shown in FIG. 12, which is a block diagram thereof, an arbitration circuit 3 and four DMA channels 4_1, 4_2, 4_3, and 4_4.

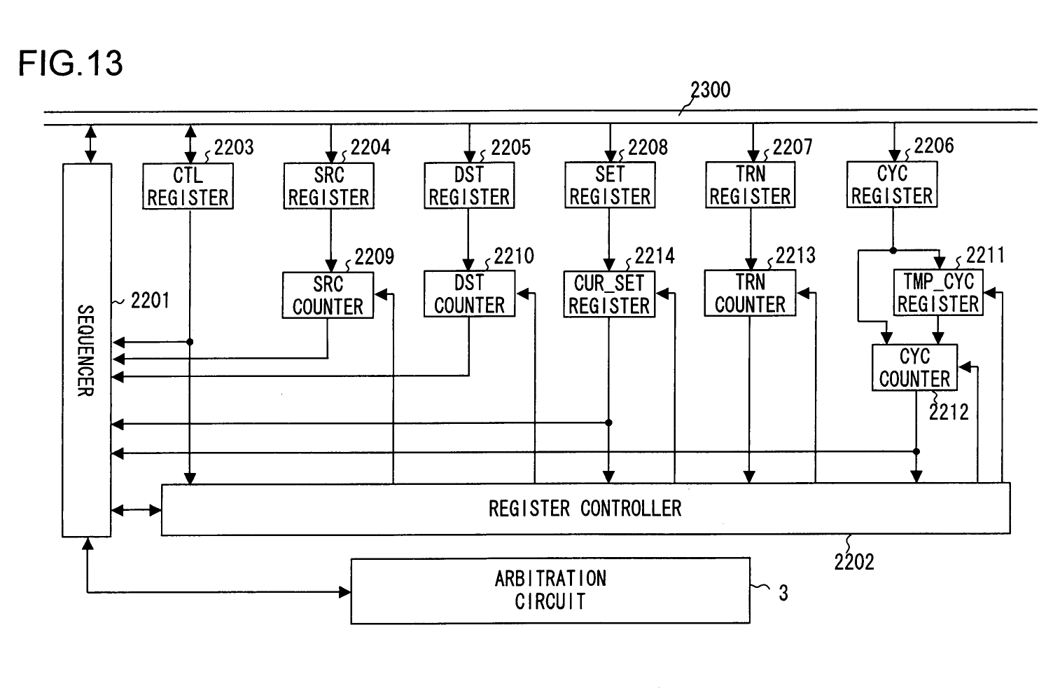

The DMA channels 4_1, 4_2, 4_3, and 4_4 each include, as shown in FIG. 13, which shows the circuit configuration thereof, a sequencer 2201, a register controller 2202, a CTL register 2203, a SRC register 2204, a DST register 2205, a CYC register 2206, a TRN register 2207, a SET register 2208, a SRC counter 2209, a DST counter 2210, a TMP_CYC register 2211, a CYC counter 2212, a TRN counter 2213, and a CUR_SET register 2214.

The arbitration circuit 3 arbitrates access to a system bus 2300, controls the sequencer 2201, and performs other operations. In each of the DMA channels 4_1, 4_2, 4_3, and 4_4, under the control of the arbitration circuit 3, and according to the contents of the CTL register 2203, SRC counter 2209, DST counter 2210, CYC counter 2212, CUR_SET register 2214, and the register (not illustrated) provided within the register controller 2202, the sequencer 2201 executes DMA transfer.

According to instructions from the sequencer 2201 and according to the contents of the CTL register 2203, CYC counter 2212, TRN counter 2213, CUR_SET register 2214, and the register provided within the register controller 2202, the register controller 2202 controls the operation of the SRC counter 2209, DST counter 2210, TMP_CYC register 2211, CYC counter 2212, TRN counter 2213, and CUR_SET register 2214, and also rewrites the register provided within the register controller 2202. The register provided within the register controller 2202 includes an EOP_O bit that indicates whether or not DMA transfer has been completed.

A CPU writes information needed to execute DMA transfer to the CTL register 2203, SRC register 2204, DST register 2205, CYC register 2206, TRN register 2207, and SET register 2208.

Specifically, the CTL register 2203 includes an ENB bit that indicates whether or not execution of DMA transfer is permitted, a RESUM bit that indicates whether or not DMA transfer is interrupted, MOD1 and MOD0 bits that indicate operation modes, a CEPE bit that indicates whether or not to notify the CPU of the end of DMA transfer by means of an interrupt signal, an NEPE bit that indicates whether or not to notify the CPU of the end of the next DMA transfer by means of an interrupt signal, and other bits. Thus, information needed to control DMA transfer is written to the CTL register 2203. To the SRC register 2204 is written the start address of the data source area (the area from which data is read). To the DST register 2205 is written the start address of the data destination area (the area to which data is written).

To the CYC register 2206 is written a value that is commensurate with the number of cycles involved in one DMA transfer session (here, one cycle consists of one read operation and one write operation). To the TRN register 2207 is written a value that is commensurate with the number of DMA transfer sessions executed. To the SET register 2208 is written other information relating to DMA transfer (for example, the size of data transferred in one cycle, whether or not to update the source and destination addresses every cycle, etc.).

The SRC counter 2209 is a counter in which the address of the source is stored and that is updated whenever necessary. The DST counter 2210 is a counter in which the address of the destination is stored and that is updated whenever necessary. The TMP_CYC register 2211 is a register in which is stored the number of cycles to be executed in one DMA transfer session. The CYC counter 2212 is a counter that counts the number of cycles that have been executed in one DMA transfer session. The TRN counter 2213 is a counter that counts the number of DMA transfer sessions that have been executed. The CUR_SET register 2214 is a register in which is stored the information written to the SET register 2208.

The data held in the SRC register 2204 is fed to the SRC counter 2209, the data held in the DST register 2205 is fed to the DST counter 2210, the data held in the CYC register 2206 is fed to TMP_CYC register 2211 and the CYC counter 2212, the data held in the TRN register 2207 is fed to the TRN counter 2213, and the data held in the SET register 2208 is fed to the CUR_SET register 2214. The data held in the TMP_CYC register 2211 is fed to the CYC counter 2212.

Now, the operation of the arbitration circuit 3 will be described in detail. When an input signal DMA_REQ2_{—}x (x=1, 2, 3, or 4) is asserted, the arbitration circuit 3 recognizes a request for DMA transfer on the DMA channel 4_{—}x. If there is any DMA channel that is waiting for DMA transfer (any DMA channel on which DMA transfer was requested but has not yet been executed), the arbitration circuit 3 requests access to the system bus 2300 from a bus controller such as one built around a CPU or the like (specifically, it asserts an output signal BUS_REQ2).

When access to the system bus 2300 is permitted (specifically, when an input signal BUS_ACK2 is asserted), the arbitration circuit 3 asserts the start signal to the sequencer 2201 of whichever of the DMA channels that are waiting for DMA transfer is given the highest priority. When access to the system bus 2300 is withdrawn (specifically, when the input signal BUS_ACK2 is negated), the arbitration circuit 3 negates the start signal to the sequencer 2201.

When a DMA wait command is issued from the bus controller (not illustrated) (specifically, when an input signal DMA_WAIT2 is asserted), the arbitration circuit 3 asserts the wait signal to the sequencer 2201 of each of the DMA channels 4_1, 4_2, 4_3, and 4_4. When the DMA wait command is cancelled (specifically, when the input signal DMA_WAIT2 is negated), the arbitration circuit 3 negates the wait signal to the sequencer 2201.

Incidentally, the bus controller controls the signal DMA_WAIT2 according to the address that the DMA controller has accessed so that the DMA controller does not proceed to the next operation before completing the reading or writing of data at the address that it has accessed.

When notified, from the sequencer 2201 of a DMA channel, that an underflow has occurred in the CYC counter 2212, the arbitration circuit 3 negates the start signal to that sequencer 2201. Thereafter, when there is any DMA channel that is waiting for DMA transfer, if access to the system bus 2300 is permitted, the arbitration circuit 3 asserts the start signal to the sequencer 2201 of whichever of such DMA channels is given the highest priority. On the other hand, if there is no DMA channel that is waiting for DMA transfer, the arbitration circuit 3 frees the system bus 2300 (specifically, it negates the output signal BUS_REQ2). When the system bus 2300 is freed, access to the system bus 2300 is withdrawn.

When notified, from the sequencer 2201 of a DMA channel, that DMA transfer has been completed, the arbitration circuit 3 negates the start signal to that sequencer 2201, and frees the system bus 2300.

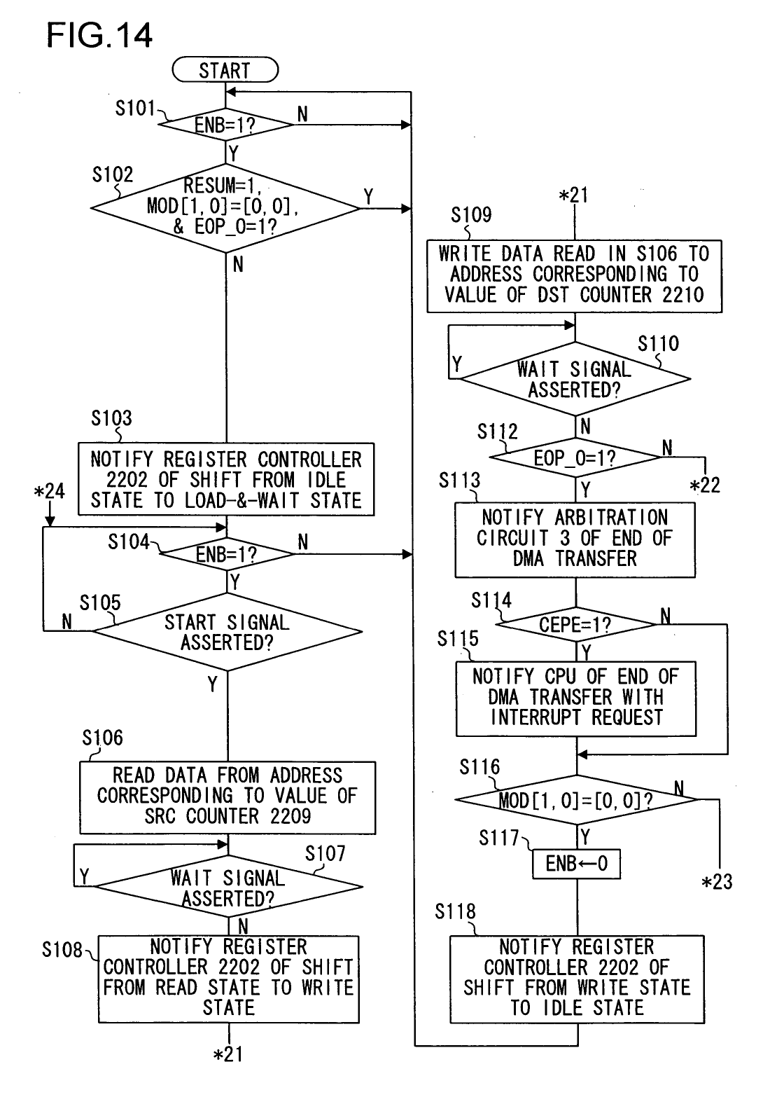

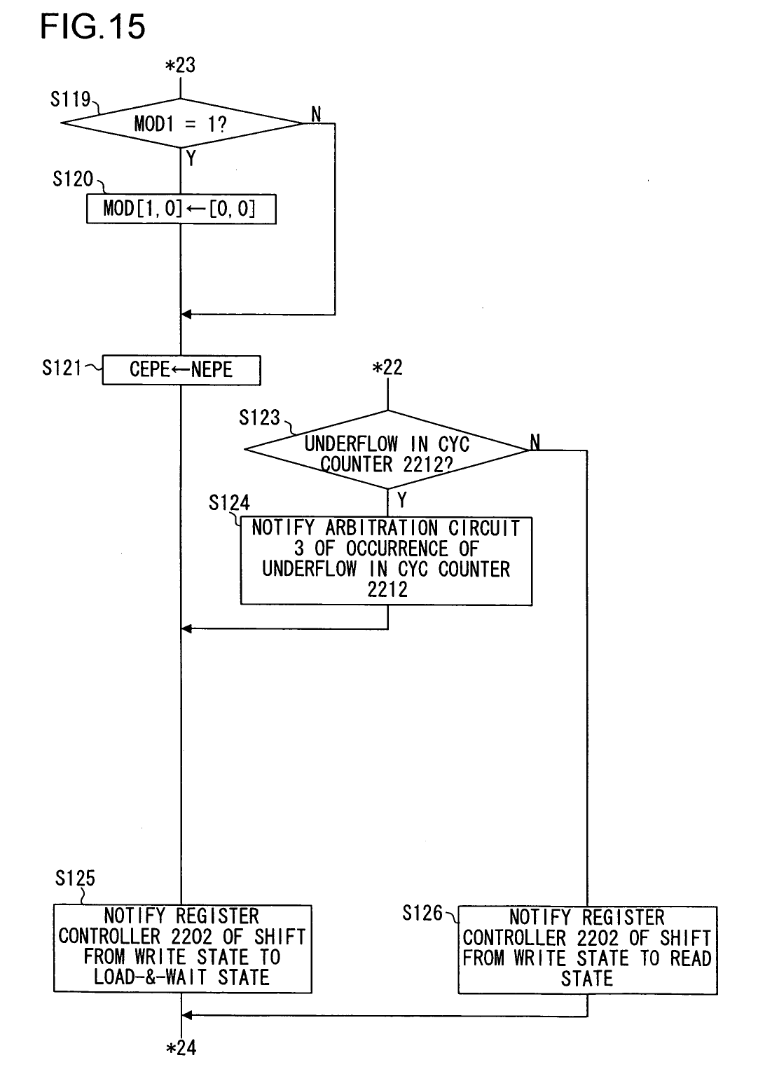

Now, the operation of the sequencer 2201 of a DMA channel will be described with reference to the flow charts shown in FIGS. 14 and 15. First, whether or not the ENB bit of the CTL register 2203 is “1” is checked (S101). If the ENB bit is “1” (“Y” in S101), the flow proceeds to S102. The ENB bit of the CTL register 2203 is a bit that indicates whether or not DMA transfer is permitted, and a “1” in this bit indicates that DMA transfer is permitted.

Incidentally, when the CPU completes making settings for DMA transfer on a DMA channel that is not currently being used, that is, when the CPU completes writing necessary information to the CTL register 2203, SRC register 2204, DST register 2205, CYC register 2206, TRN register 2207, and SET register 2208, it sets the ENB bit of the CTL register 2203 to “1.”

In S102, whether or not the RESUM bit, MOD1 bit, and MOD0 bit of the CTL register 2203 are “1,” “0” and “0,” respectively and in addition the EOP_O bit of the register provided within the register controller 2202 is “1” is checked. If the check in S102 results in “yes” (“Y” in S102), an idle state is recognized, and the flow returns to S101 described above; on the other hand, if it results in “no” (“N” in S102), the register controller 2202 is notified of a shift from an idle state to a load-and-wait state (S103).

Incidentally, the CPU, after it has interrupted DMA transfer by setting the ENB bit of the CTL register 2203 to “0,” sets the RESUM bit of the CTL register 2203 to “1” prior to restarting DMA transfer by setting the ENB bit to “1.” That is, the RESUM bit of the CTL register 2203 is a bit that indicates whether or not DMA transfer has been interrupted or not, and a “1” in this bit indicates that DMA transfer has been interrupted.

The MOD1 and MOD0 bits of the CTL register 2203 are bits that specify the mode in which DMA transfer is executed. The EOP_O bit of the register provided within the register controller 2202 is a bit that indicates whether or not DMA transfer has been completed, and a “1” in this bit indicates that DMA transfer has been completed

On completion of S103, whether or not the ENB bit of the CTL register 2203 is “1” is checked (S104). If the ENB bit is “1” (“Y” in S104), the idle state is recognized to have been cancelled, and the flow proceeds to S105. On the other hand, if the ENB bit is not “1” (“N” in S104), the idle state is recognized to be still prevailing, and the flow returns to S101.

In S105, whether or not the start signal from the arbitration circuit 3 is asserted is checked. If the start signal is asserted (“Y” in S105), the flow proceeds to S106; on the other hand, if the start signal is not asserted (“N” in S105), the flow returns to S104 described above.

In S106, the data at the address corresponding to the value of the SRC counter 2209 is read to a buffer of the sequencer 2201 itself. On completion of S106, whether or not the wait signal from the arbitration circuit 3 is asserted is checked (S107). If the wait signal is not asserted (“N” in S107), the flow proceeds to S108.

In S108, the register controller 2202 is notified of a shift from a read state to a write state. On completion of S108, the data read in S106 is written to the address corresponding to the value of the DST counter 2210 (S109). Next, whether or not the wait signal is asserted is checked (S110), and, if the wait signal is not asserted (“N” in S110), the flow proceeds to S112.

In S112, whether or not the EOP_O bit of the register provided within the register controller 2202 is “1” is checked. If the EOP_O bit is “1”, (“Y” in S112), the arbitration circuit 3 is notified of the end of DMA transfer (S113); on the other hand, if the EOP_O bit is not “1,” (“N” in S112), the flow proceeds to S123 described later.

On completion of S113, whether or not the CEPE bit of the CTL register 2203 is “1” is checked (S114). If the CEPE bit is “1” (“Y” in S114), the CPU is notified, by means of an interrupt signal, that DMA transfer has been completed (S115), and then the flow proceeds to S116. On the other hand, if the CEPE bit is not “1” (“N” in S114), the flow skips S115 and proceeds directly to S116.

In S116, whether or not the MOD1 and MOD0 bits of the CTL register 2203 are both “0” is checked. If the check in S116 results in “yes” (“Y” in S116), the ENB bit of the CTL register 2203 is set to “0” (S117), and in addition the register controller 2202 is notified of a shift from a write state to an idle state (S118). On completion of S118, the flow proceeds to S101 described above. On the other hand, if the check in S116 results in “no” (“N” in S116), the flow proceeds to S119.

In S119, whether or not the MOD1 bit of the CTL register 2203 is “1” is checked. If the MOD1 bit is “1” (“Y” in S119), the MOD1 and MOD0 bits are both set to “0” (S120), and in addition the value of the CEPE bit of the CTL register 2203 is updated with the value of the NEPE bit of the CTL register 2203 (S121)

On the other hand, if the MOD1 bit is not “1” (“N” in S119), the flow skips S120 and directly executes S121. On completion of S121, the register controller 2202 is notified of a shift from a write state to a load-and-wait (S125), and then the flow returns to S104 described above.

In S123, to which the flow proceeds if the check in S112 results in “no” (“N” in S112), whether or not an underflow is occurring in the CYC counter 2212 is checked. If an underflow is occurring in the CYC counter 2212 (“Y” in S123), the arbitration circuit 3 is notified of the occurrence of the underflow (S124), and the register controller 2202 is notified of a shift from a write state to a load-and-wait state (S125). On completion of S125, the flow returns to S104 described above.

On the other hand, if no underflow is occurring in the CYC counter 2212 (“N” in S123), the register controller 2202 is notified of a shift from a write state to a read state (S126). On completion of S126, the flow returns to S104 described above.

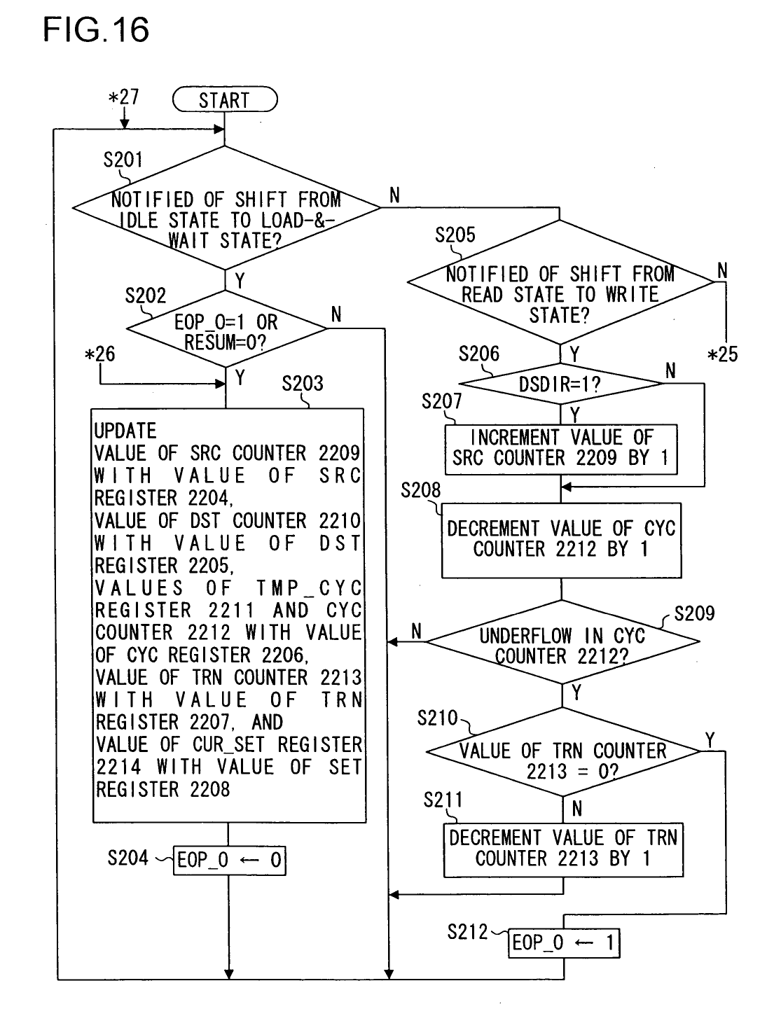

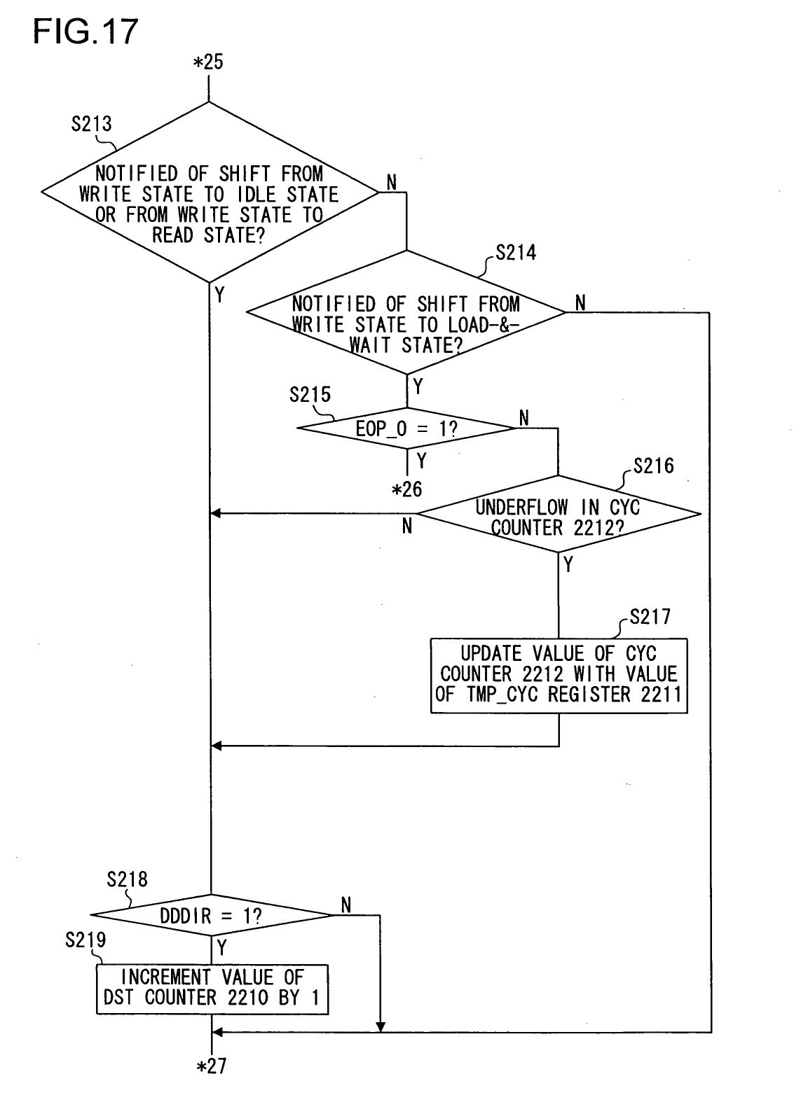

Now, the operation of the register controller 2202 will be described with reference to the flow charts shown in FIGS. 16 and 17. The register controller 2202 monitors notifications of shifts in status from the sequencer 2201 (S201, S205, S213, and S214).

First, a description will be given of a case where the register controller 2202 is notified, from the sequencer 2201, of a shift from an idle state to a load-and-wait state. In this case, the check in S201 results in “yes” (“Y” in S201), and whether or not the EOP_O bit of the register provided within the register controller 2202 itself is “1,” or whether or not the RESUM bit of the CTL register 2203 is “0,” is checked (S202).

If the check in S202 results in “yes” (“Y” in S202), the data of the SRC counter 2209 is updated with the data of the SRC register 2204, the data of the DST counter 2210 is updated with the data of the DST register 2205, the data of the TMP_CYC register 2211 and the CYC counter 2212 is updated with the data of the CYC register 2206, the data of the TRN counter 2213 is updated with the data of the TRN register 2207, the data of the CUR_SET register 2214 is updated with the data of the SET register 2208 (S203). On completion of S203, the EOP_O bit of the register provided within the register controller 2202 itself is set to “0” (S204).

Next, a description will be given of a case where the register controller 2202 is notified, from the sequencer 2201, of a shift from a read state to a write state. In this case, the check in S205 results in “yes” (“Y” in S205), and whether or not a DSDIR bit of the CUR_SET register 2214 is “1” is checked (S206).

If the DSDIR bit is “1” (“Y” in S206”), the value of the SRC counter 2209 is incremented by one (S207), and then the flow proceeds to S208. On the other hand, if the DSDIR bit is not “1” (“N” in S206), the flow skips S207 and proceeds directly to S208.

In S208, the value of the CYC counter 2212 are decremented by one. On completion of S208, whether or not an underflow is occurring in the CYC counter 2212 is checked (S209). If an underflow is occurring in the CYC counter 2212 (“Y” in S209), whether or not the value of the TRN counter 2213 is “0” is checked (S210).

If the value of the TRN counter 2213 is not “0” (“N” in S210), the value of the TRN counter 2213 is decremented by one (S211). On the other hand, if the value of the TRN counter 2213 is “0” (“Y” in S210), the EOP_O bit of the register provided within the register controller 2202 itself is set to “1” (S212).

Next, a description will be given of a case where the register controller 2202 is notified, from the sequencer 2201, of a shift from a write state to an idle state or a shift from a write state to a read state. In this case, the check in S213 results in “yes” (“Y” in S213), and whether or not a DDDIR bit of the CUR_SET register 2214 is “1” is checked (S218). If the DDDIR bit is “1” (“Y” in S218), the value of the DST counter 2210 is incremented by one (S219).

Next, a description will be given of a case where the register controller 2202 is notified, from the sequencer 2201, of a shift from a write state to a load-and-wait state. In this case, the check in S214 results in “yes” (“Y” in S214), and whether or not the EOP_O bit of the register provided within the register controller 2202 itself is “1” is checked (S215).

If the EOP_O bit is “1” (“Y” in S215), the values of the SRC counter 2209, DST counter 2210, TMP_CYC register 2211 and CYC counter 2212, TRN counter 2213, and CUR_SET register 2214 are updated with the values of the SRC register 2204, DST register 2205, CYC register 2206, TRN register 2207, and SET register 2208, respectively (S203), and in addition the EOP_O bit of the register provided within the register controller 2202 itself is set to “0” (S204). On the other hand, if the EOP_O bit is not “1” (“N” in S215), whether or not an underflow is occurring in the CYC counter 2212 is checked (S216).

If an underflow is occurring in the CYC counter 2212 (“Y” in S216), the value of the CYC counter 2212 is updated with the value of the TMP_CYC register 2211 (S217), and then the flow proceeds to S218. On the other hand, if no underflow is occurring in the CYC counter 2212 (“N” in S216), the flow skips S217 and directly executes S218.

In S218, whether or not the DDDIR bit of the CUR_SET register 2214 is “1” is checked. If the DDDIR bit is “1” (“Y” in S218), the value of the DST counter 2210 is incremented by one (S219).

As the result of the sequencer 2201 and the register controller 2202 operating as described above, in each of the DMA channels, before DMA transfer is started, the values of the group of setting registers (the SRC register 2204, DST register 2205, CYC register 2206, TRN register 2207, and SET register 2208) are written to the group of operation registers or operation counters (the SRC counter 2209, DST counter 2210, TMP_CYC register 2211, CYC counter 2212, TRN counter 2213, and CUR_SET register 2214), and DMA transfer is executed according to the values of the group of operation registers or operation counters.

Thus, by writing information needed for DMA transfer to the group of setting registers with desired timing, it is possible to make settings for DMA transfer even on a DMA channel that is currently being used. Accordingly, when DMA transfer needs to be executed in a given task, even when all the DMA channels are currently being used, it is possible to make settings for DMA transfer without waiting for the end of DMA transfer. This helps reduce the wasting of the CPU's processing time resulting from task switching and the like.

According to the MOD1 and MOD0 bits of the CTL register 2203, a DMA channel operates in different modes as described below. On completion of DMA transfer, if the MOD1 and MOD0 bits are both set to “0,” the DMA channel goes into an idle state (in which DMA transfer is inhibited) (hereinafter referred to as the “normal mode 2”).

On completion of DMA transfer, if the MOD1 and MOD0 bits are set to “0” and “1,” respectively, the DMA channel goes into a load-and-wait state (in which the DMA channel, having updated the values of the group of operation registers or operation counters with those of the group of setting registers, is waiting for a request for DMA transfer). Thus, the next DMA transfer is started without intervention of the CPU (hereinafter referred to as the “autorepeat mode 2”).

On completion of DMA transfer, if the MOD1 bit is set to “1,” the DMA channel sets both the MOD1 and MOD0 bits to “0” and then goes into a load-and-wait state. Thus, the next DMA transfer is started without intervention of the CPU, and then, on completion of this DMA transfer, the DMA channel goes into an idle state (hereinafter referred to as the “autostart mode 2”).

Accordingly, the CPU has only to rewrite the MOD1 and MOD0 bits of the CTL register 2203 to make the individual DMA channels change their operation mode in such a way that: when settings for DMA transfer are made on a DMA channel that is not currently being used, the DMA channel operates in the normal mode 2; when DMA transfer needs to be executed repeatedly with the same settings, the relevant DMA channel operates in the autorepeat mode 2; and, when settings for DMA transfer are made on a DMA channel that is currently being used, the DMA channel operates in the autostart mode 2.

On completion of DMA transfer, if the CEPE bit of the CTL register 2203 is “0,” no interrupt request is sent to the CPU to notify it of the end of DMA transfer. Thus, when the CPU has made settings for the next DMA transfer, so long as the CEPE bit is set to “0,” the CPU does not receive an interrupt request from the DMA controller even at the end of the immediately previously set DMA transfer. This helps eliminate meaningless interrupt requests from the DMA controller and thereby save more time for other operations.

When the CPU has access to the system bus 2300, it can rewrite the values of the CTL register 2203 at any time to switch the operation mode of the DMA channels and whether or not to send an interrupt request on completion of DMA transfer. This makes it possible to flexibly cope with varying situations.

Let the value set in the CYC register 2206 be p, and let the value set in the TRN register 2207 be q. Then, every time DMA transfer is requested, (p+1) DMA transfer cycles are executed, and thereafter a stand-by state prevails until a new request for DMA transfer occurs. Eventually, when DMA transfer is completed in response to the (q+1)th request for DMA transfer, the entire operation is ended. That is, (q+1) DMA transfer sessions each consisting of (p+1) cycles are executed.

Accordingly, when the CPU wants to execute B DMA transfer sessions each consisting of A cycles, it has only to set, only once, the values of the CYC register 2206 and the TRN resistor to A−1 and B−1, respectively. This helps reduce the burden on the CPU, and thus helps alleviate the lowering of system performance.

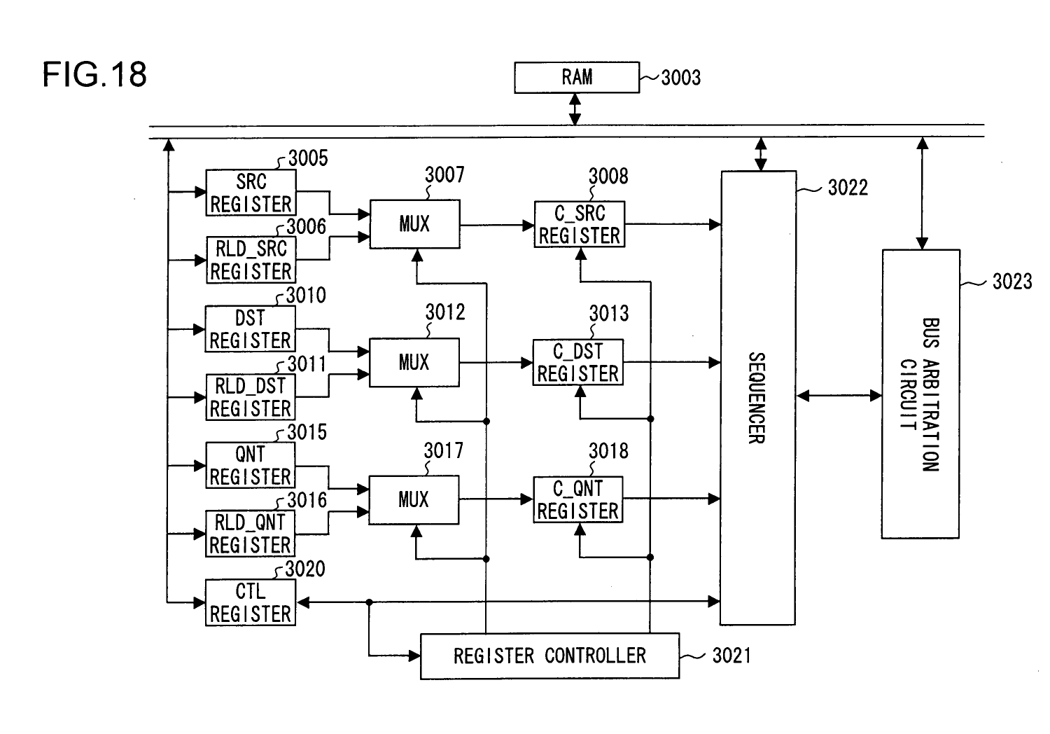

Next, the DMA controller of a third embodiment of the invention will be described. FIG. 18 is a block diagram of the DMA controller of the third embodiment. In the DMA controller of this embodiment, there is provided a set of an operation register, a setting register, and a setting execution register for each item of transfer conditions for DMA transfer, namely the source start address, the destination start address, and the data transfer amount.

A C_SRC register 3008 is an operation register for the source start address, a SRC register 3005 is a setting register for the source start address, a RLD_SRC register 3006 is a setting execution register for the source start address, and a multiplexer 3007 functions as a selector for alternatively choosing between the SRC register 3005 and the RLD_SRC register 3006.

A C_DST register 3013 is an operation register for the destination start address, a DST register 3010 is a setting register for the destination start address, a RLD_DST register 3011 is a setting execution register for the destination start address, and a multiplexer 3012 functions as a selector for alternatively choosing between the DST register 3010 and the RLD_DST register 3011.

A C_QNT register 3018 is an operation register for the data transfer amount, a QNT register 3015 is a setting register for the data transfer amount, a RLD_QNT register 3016 is a setting execution register for the data transfer amount, and a multiplexer 3017 functions as a selector for alternatively choosing between the QNT register 3015 and the RLD_QNT register 3016.

Moreover, there are also provided a CTL (control) register 3020 for controlling DMA transfer, a register controller 3021, a sequencer 3022, and a bus arbitration circuit 3023. The CTL register 3020 includes, among others, an ENB bit that indicates whether or not DMA transfer is permitted (if ENB bit=1, DMA transfer is permitted), and a RLD_ENB bit that determines whether or not to automatically acquire the transfer conditions for the next DMA transfer after completion of DMA transfer of transfer conditions for DMA transfer from a storage device (in FIG. 18, a RAM 3003) (if RLD_ENB bit=1, the transfer conditions are automatically acquired from the external storage device).

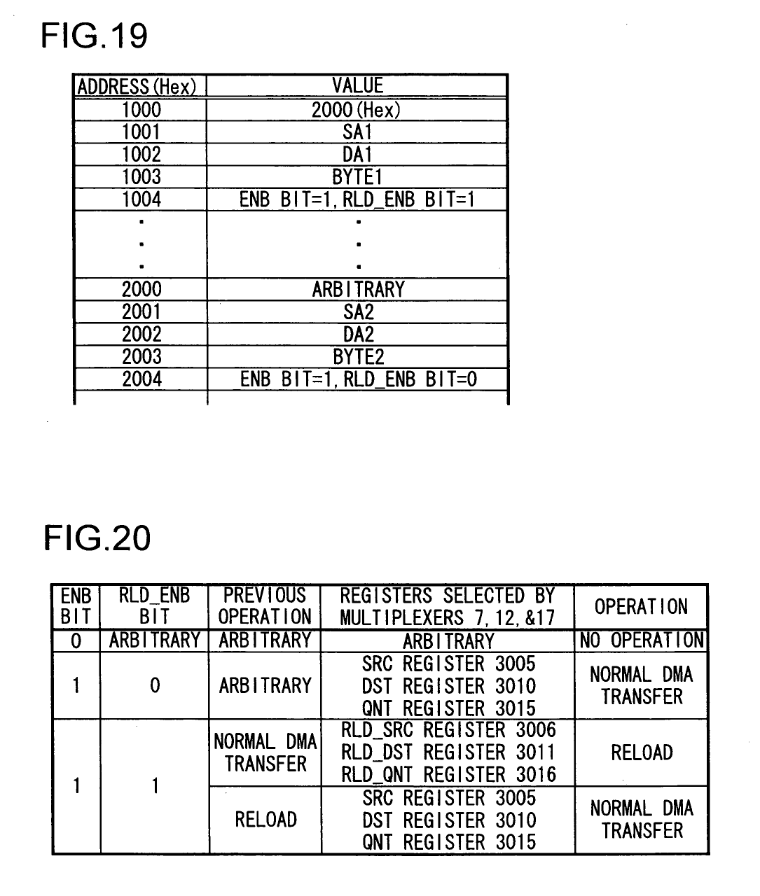

Now, the operation of the DMA controller of the third embodiment will be described. Suppose now that two DMA transfer sessions are going to be executed under different sets of transfer conditions. First, a CPU writes to the RAM 3003 shown in FIG. 18 the transfer conditions for the two DMA transfer sessions. Here, it is assumed that, as a result, the contents in the RAM 3003 are now as shown in FIG. 19.

Specifically, assume that, as a set #1 of transfer conditions under which to execute the first DMA transfer session, the following data is written to the RAM 3003: at address 1000(Hex) is written the start address in the RAM 3003 where the transfer conditions for the second DMA transfer session is written; at address 1001(Hex) is written the source start address SA1 for the first DMA transfer session; at address 1002(Hex) is written the destination start address DA1 for the first DMA transfer session; at address 1003(Hex) is written the data transfer amount BYTE1 for the first DMA transfer session; and at address 1004(Hex) is written the contents of the CTL register 3020 after completion of the first DMA transfer session (ENB bit=1 and RLD_ENB bit=1).

Moreover, assume that, as a set #2 of transfer conditions under which to execute the second DMA transfer session, the following data is written to the RAM 3003: at address 2000(Hex) is written an arbitrary value (because, only two DMA transfer sessions are supposed to be executed); at address 2001(Hex) is written the source start address SA2 for the second DMA transfer session; at address 2002(Hex) is written the destination start address DA2 for the second DMA transfer session; at address 2003(Hex) is written the data transfer amount BYTE2 for the second DMA transfer session; and at address 2004(Hex) is written the contents of the CTL register 3020 after completion of the second DMA transfer session (ENB bit=0 and RLD_ENB bit=0).

Then, the CPU writes appropriate values to the individual setting execution registers. Specifically, to the RLD_SRC register 3006 is written the start address 1000(Hex) in the RAM 3003 where the transfer conditions for the first DMA transfer session is written. To the RLD_DST register 3011 is written the address of the RLD_SRC register 3006. To the RLD_QNT register 3016 is written “5” (because five DMA transfer sessions are needed to acquire transfer conditions for DMA transfer from the RAM 3003).

Moreover, the CPU gets access to the CTL register 3020 of the DMA controller, and writes to it so that ENB bit=1 and RLD_ENB bit=1. At this time, in the DMA controller, as shown in FIG. 20, according to the ENB and RLD_ENB bits and the previous operation, the registers chosen by the multiplexers 3007, 3012, and 3017 are switched. Then, the values of the C_SRC register 3008, C_DST register 3013, and C_QNT register 3018 are updated with the values of the registers chosen by the multiplexer 3007, 3012, and 3017, and then the sequencer 3022 starts DMA transfer according to the C_SRC register 3008, C_DST register 3013, and C_QNT register 3018.

At this moment, ENB bit=1 and RLD_ENB bit=1, and in addition the previous operation is not a reload operation (whereby transfer conditions for DMA transfer are automatically acquired from the RAM 3003), and therefore the multipliers 3007, 3012, and 3017 choose the RLD_SRC register 3006, RLD_DST register 3011, and RLD_QNT register 3016, respectively. Accordingly, the sequencer 3022 executes DMA transfer by using as initial values the values of the RLD_SRC register 3006, RLD_DST register 3011, and RLD_QNT register 3016.

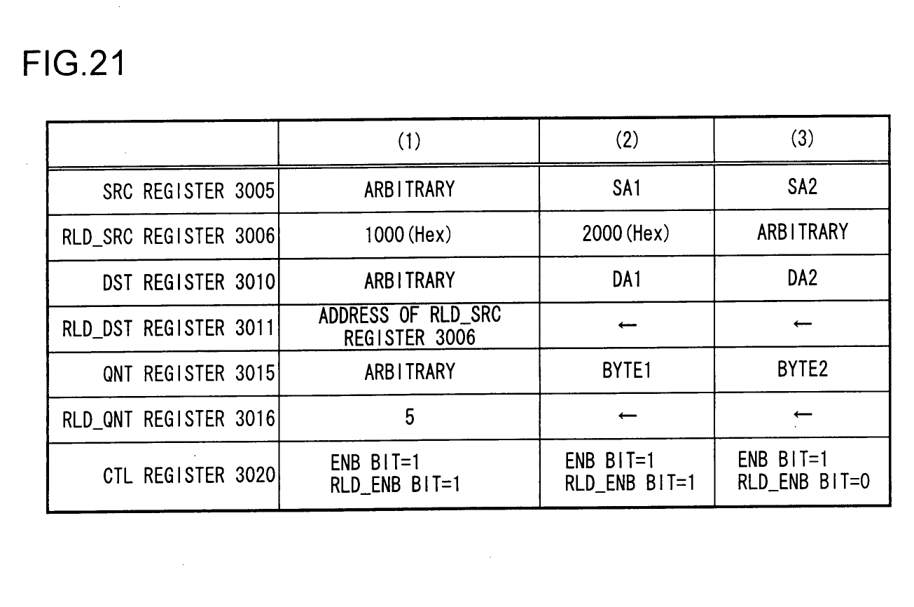

At this time point, the contents of the registers of the DMA controller are as shown under (1) in FIG. 21. Thus, DMA transfer is so executed as to transfer, sequentially, the value 2000(Hex) stored at address 1000(Hex) in the RAM 3003 to the RLD_SRC register 3006, the value SA1 stored at address 1001(Hex) in the RAM 3003 to the SRC register 3005, the value DA1 stored at address 1002(Hex) in the RAM 3003 to the DST register 3010, the value BYTE1 stored at address 1003(Hex) in the RAM 3003 to the QNT register 3015, and the data (ENB bit=1 and RLD_ENB bit=1) stored at address 1004(Hex) in the RAM 3003 to the CTL register 3020. That is, the DMA controller automatically acquires the set #1 of transfer conditions for the first DMA transfer session from the RAM 3003. At this time point, the contents of the registers of the DMA controller are as shown under (2) in FIG. 21.

Thereafter, when a request for DMA transfer occurs, in the DMA controller, as shown in FIG. 20, according to the ENB and RLD_ENB bits and the previous operation, the registers chosen by the multiplexers 3007, 3012, and 3017 are switched. Then, the values of the C_SRC register 3008, C_DST register 3013, and C_QNT register 3018 are updated with the values of the registers chosen by the multiplexer 3007, 3012, and 3017, and then the sequencer 3022 starts DMA transfer according to the C_SRC register 3008, C_DST register 3013, and C_QNT register 3018.

At this moment, ENB bit=1 and RLD_ENB bit=1, and in addition the previous operation is a reload operation, and therefore the multipliers 3007, 3012, and 3017 choose the SRC register 3005, DST register 3010, and QNT register 3015, respectively. Accordingly, the sequencer 3022 executes DMA transfer by using as initial values the values of the SRC register 3005, DST register 3010, and QNT register 3015. In this way, the first DMA transfer session is executed.

On completion of this DMA transfer, as shown in FIG. 20, according to the ENB and RLD_ENB bits and the previous operation, the registers chosen by the multiplexers 3007, 3012, and 3017 are switched. Then, the values of the C_SRC register 3008, C_DST register 3013, and C_QNT register 3018 are updated with the values of the registers chosen by the multiplexer 3007, 3012, and 3017, and then the sequencer 3022 starts DMA transfer according to the C_SRC register 3008, C_DST register 3013, and C_QNT register 3018.

At this moment, ENB bit=1 and RLD_ENB bit=1, and in addition the previous operation is not a reload operation, and therefore the multipliers 3007, 3012, and 3017 choose the RLD_SRC register 3006, RLD_DST register 3011, and RLD QNT register 3016, respectively. Accordingly, the sequencer 3022 executes DMA transfer by using as initial values the values of the RLD_SRC register 3006, RLD_DST register 3011, and RLD_QNT register 3016.

As a result, at this time point, the contents of the registers of the DMA controller are as shown under (2) in FIG. 21. Thus, DMA transfer is so executed as to transfer, sequentially, the value stored at address 2000(Hex) in the RAM 3003 to the RLD_SRC register 3006, the value SA2 stored at address 2001(Hex) in the RAM 3003 to the SRC register 3005, the value DA2 stored at address 2002(Hex) in the RAM 3003 to the DST register 3010, the value BYTE2 stored at address 2003(Hex) in the RAM 3003 to the QNT register 3015, and the data (ENB bit=1 and RLD_ENB bit=0) stored at address 2004(Hex) in the RAM 3003 to the CTL register 3020. That is, the DMA controller automatically acquires the set #2 of transfer conditions for the second DMA transfer session from the RAM 3003. At this time point, the contents of the registers of the DMA controller are as shown under (3) in FIG. 21.

Thereafter, when a request for DMA transfer occurs, as shown in FIG. 20, according to the ENB and RLD_ENB bits and the previous operation, the choices made by the multiplexers 3007, 3012, and 3017 are switched to update the values of the C_SRC register 3008, C_DST register 3013, and C_QNT register 3018. Then, the sequencer 3022 starts DMA transfer.

At this moment, ENB bit=1 and RLD_ENB bit=0, and therefore the multipliers 3007, 3012, and 3017 choose the SRC register 3005, DST register 3010, and QNT register 3015, respectively. Accordingly, the sequencer 3022 executes DMA transfer by using as initial values the values of the SRC register 3005, DST register 3010, and QNT register 3015. In this way, the second DMA transfer session is executed.

As described above, the CPU has only to write transfer conditions under which to execute DMA transfer to the RAM 3003 and then set ENB bit=1 and RLD_ENB bit=1 in the CTL register of the DMA controller in order to make the DMA controller alternately and repeatedly perform the operation of, on completion of DMA transfer, automatically acquiring the transfer conditions under which to execute the next DMA transfer from the RAM 3003 and the operation of executing DMA transfer under the thus acquired transfer conditions.

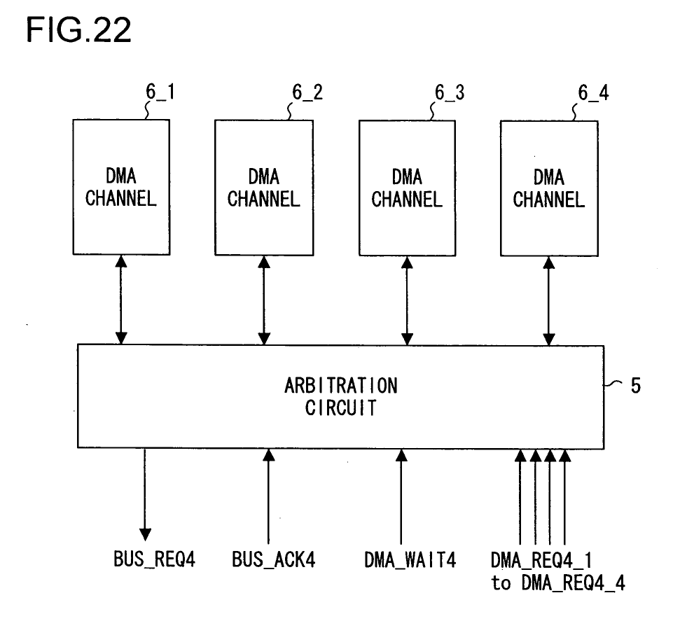

Next, the DMA controller of a fourth embodiment of the invention will be described. The DMA controller of the fourth embodiment includes, as shown in FIG. 22, which is a block diagram thereof, an arbitration circuit 5 and four DMA channels 6_1, 6_2, 6_3, and 6_4.

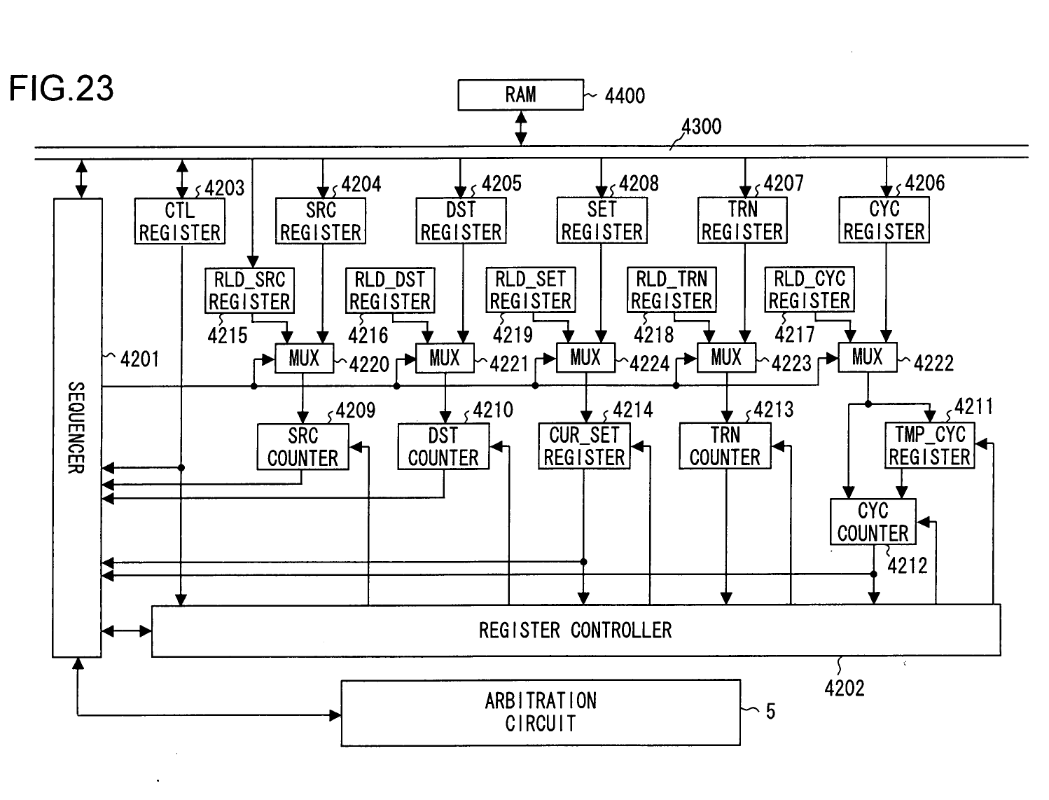

The DMA channels 6_1, 6_2, 6_3, and 6_4 each include, as shown in FIG. 23, which shows the circuit configuration thereof, a sequencer 4201, a register controller 4202, a CTL register 4203, a SRC register 4204, a DST register 4205, a CYC register 4206, a TRN register 4207, a SET register 4208, a SRC counter 4209, a DST counter 4210, a TMP_CYC register 4211, a CYC counter 4212, a TRN counter 4213, a CUR_SET register 4214, an RLD_SRC register 4215, an RLD_DST register 4216, an RLD_CYC register 4217, an RLD_TRN register 4218, an RLD_SET register 4219, and multiplexers 4220, 4221, 4222, 4223, and 4224.

The arbitration circuit 5 arbitrates access to a system bus 4300, controls the sequencer 4201, and performs other operations. In each of the DMA channels 6_1, 6_2, 6_3, and 6_4, under the control of the arbitration circuit 5, and according to the contents of the CTL register 4203, SRC counter 4209, DST counter 4210, CYC counter 4212, CUR_SET register 4214, and the register (not illustrated) provided within the register controller 4202, the sequencer 4201 executes DMA transfer. Here, the arbitration circuit 5 is provided with a register including a reload bit for controlling the choices made by the multiplexers 4220, 4221, 4222, 4223, and 4224.

According to instructions from the sequencer 4201 and according to the contents of the CTL register 4203, CYC counter 4212, TRN counter 4213, CUR_SET register 4214, and the register provided within the register controller 4202, the register controller 4202 controls the operation of the SRC counter 4209, DST counter 4210, TMP_CYC register 4211, CYC counter 4212, TRN counter 4213, and CUR_SET register 4214, and also rewrites the register provided within the register controller 4202. The register provided within the register controller 4202 includes an EOP_O bit that indicates whether or not DMA transfer has been completed.

The CTL register 4203 includes an ENB bit that indicates whether or not execution of DMA transfer is permitted, a RESUM bit that indicates whether or not DMA transfer is interrupted, MOD1 and MOD0 bits that indicate operation modes, a S/W_START bit that permits DMA transfer to be started by software, a CEPE bit that indicates whether or not to notify the CPU of the end of DMA transfer by means of an interrupt signal, an NEPE bit that indicates whether or not to notify the CPU of the end of the next DMA transfer by means of an interrupt signal, and other bits. Thus, information needed to control DMA transfer is written to the CTL register 4203. To the SRC register 4204, DST register 4205, CYC register 4206, TRN register 4207, and SET register 4208 are written transfer conditions for DMA transfer.

Specifically, to the SRC register 4204 is written the start address of the data source area (the area from which data is read). To the DST register 4205 is written the start address of the data destination area (the area to which data is written). To the CYC register 4206 is written a value that is commensurate with the number of cycles involved in one DMA transfer session (here, one cycle consists of one read operation and one write operation). To the TRN register 4207 is written a value that is commensurate with the number of DMA transfer sessions executed. To the SET register 4208 is written other information relating to DMA transfer (for example, the size of data transferred in one cycle, whether or not to update the source and destination addresses every cycle, etc.).

The SRC counter 4209 is a counter in which the address of the source is stored and that is updated whenever necessary. The DST counter 4210 is a counter in which the address of the destination is stored and that is updated whenever necessary. The TMP_CYC register 4211 is a register in which is stored the number of cycles to be executed in one DMA transfer session. The CYC counter 4212 is a counter that counts the number of cycles that have been executed in one DMA transfer session. The TRN counter 4213 is a counter that counts the number of DMA transfer sessions that have been executed. The CUR_SET register 4214 is a register in which is stored the information written to the SET register 4208.

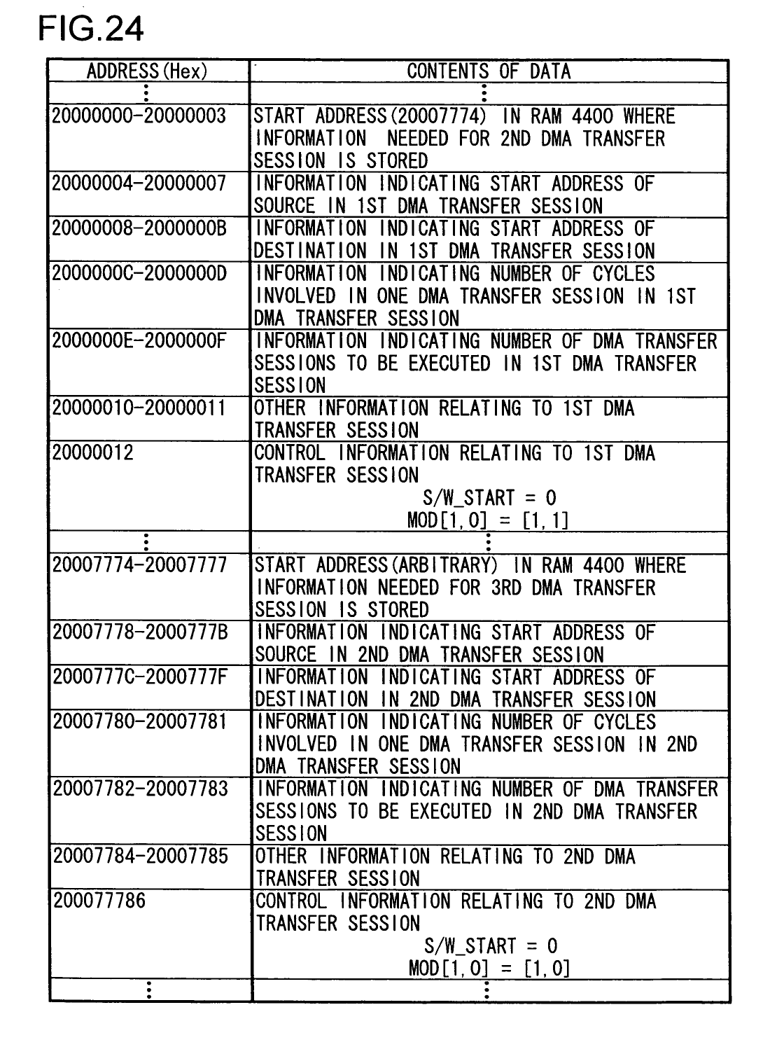

As will be described later, the DMA controller of this embodiment has a mode (called the reload mode 4) in which, when DMA transfer is executed, the transfer conditions therefor is transferred by DMA transfer from a RAM 4400 to the DMA controller itself. When the CPU makes the DMA controller execute DMA transfer in this reload mode 4, as an example is shown in FIG. 24, the CPU writes, for each DMA transfer session to be executed, the start address in the RAM 4400 where the transfer conditions under which to execute DMA transfer next time is written and the transfer conditions themselves under which to execute DMA transfer this time (information indicating the start address of the source, information indicating the start address of the destination, information indicating the number of cycles to be executed in one DMA transfer session, information indicating the number of DMA transfer sessions to be executed, other information, and control information) to a contiguous area in the RAM 4400. In the example shown in FIG. 24, two DMA transfer sessions have been set.

The RLD_SRC register 4215 is a register to which the CPU writes the start address in the RAM 4400 where the transfer conditions for DMA transfer is written. The RLD_DST register 4216, RLD_CYC register 4217, RLD_TRN register 4218, and RLD_SET register 4219 are registers to which are written the transfer conditions under which to transfer by DMA transfer from the RAM 4400 to the group of setting registers of the relevant DMA channel (the SRC register 4204, DST register 4205, CYC register 4206, TRN register 4207, and SET register 4208) the transfer conditions under which to execute DMA transfer.

The multiplexer 4220 chooses either the data held in the SRC register 4204 or the data held in the RLD_SRC register 4215 according to an instruction from the sequencer 4201. The data chosen by the multiplexer 4220 is fed to the SRC counter 4209.

The multiplexer 4221 chooses either the data held in the DST register 4205 or the data held in the RLD_DST register 4216 according to an instruction from the sequencer 4201. The data chosen by the multiplexer 4221 is fed to the DST counter 4210.

The multiplexer 4222 chooses either the data held in the CYC register 4206 or the data held in the RLD_CYC register 4217 according to an instruction from the sequencer 4201. The data chosen by the multiplexer 4222 is fed to the TMP_CYC register 4211 and the CYC counter 4212. To the CYC counter 4212 is also fed the data held in the TMP_CYC register 4211.

The multiplexer 4223 chooses either the data held in the TRN register 4207 or the data held in the RLD_TRN register 4218 according to an instruction from the sequencer 4201. The data chosen by the multiplexer 4223 is fed to the TRN counter 4213.

The multiplexer 4224 chooses either the data held in the SET register 4208 or the data held in the RLD_SET register 4219 according to an instruction from the sequencer 4201. The data chosen by the multiplexer 4224 is fed to the CUR_SET register 4214.

Now, the operation of the arbitration circuit 5 will be described in detail. When an input signal DMA_REQ4_{—}x (x=1, 2, 3, or 4) is asserted, the arbitration circuit 5 recognizes a request for DMA transfer on the DMA channel 6_{—}x. If there is any DMA channel that is waiting for DMA transfer (any DMA channel on which DMA transfer was requested but has not yet been executed), the arbitration circuit 5 requests access to the system bus 4300 (specifically, it asserts an output signal BUS_REQ4).

When access to the system bus 4300 is permitted (specifically, when an input signal BUS_ACK4 is asserted), the arbitration circuit 5 asserts the start signal to the sequencer 4201 of whichever of the DMA channels that are waiting for DMA transfer is given the highest priority. When access to the system bus 4300 is withdrawn (specifically, when the input signal BUS_ACK4 is negated), the arbitration circuit 5 negates the start signal to the sequencer 4201.

When a DMA wait command is issued from a bus controller (not illustrated) (specifically, when an input signal DMA_WAIT4 is asserted), the arbitration circuit 5 asserts the wait signal to the sequencer 4201 of each of the DMA channels 6_1, 6_2, 6_3, and 6_4. When the DMA wait command is cancelled (specifically, when the input signal DMA_WAIT4 is negated), the arbitration circuit 5 negates the wait signal to the sequencer 4201.

Incidentally, the bus controller controls the signal DMA_WAIT4 according to the address that the DMA controller has accessed so that the DMA controller does not proceed to the next operation before completing the reading or writing of data at the address that it has accessed.

When notified, from the sequencer 4201 of a DMA channel, that an underflow has occurred in the CYC counter 4212, the arbitration circuit 5 negates the start signal to that sequencer 4201. Thereafter, when there is any DMA channel that is waiting for DMA transfer, if access to the system bus 4300 is permitted, the arbitration circuit 5 asserts the start signal to the sequencer 4201 of whichever of such DMA channels is given the highest priority. On the other hand, if there is no DMA channel that is waiting for DMA transfer, the arbitration circuit 5 frees the system bus 4300 (specifically, it negates the output signal BUS_REQ4). When the system bus 4300 is freed, access to the system bus 4300 is withdrawn.

When notified, from the sequencer 4201 of a DMA channel, that DMA transfer has been completed, the arbitration circuit 5 negates the start signal to that sequencer 4201, and frees the system bus 4300.

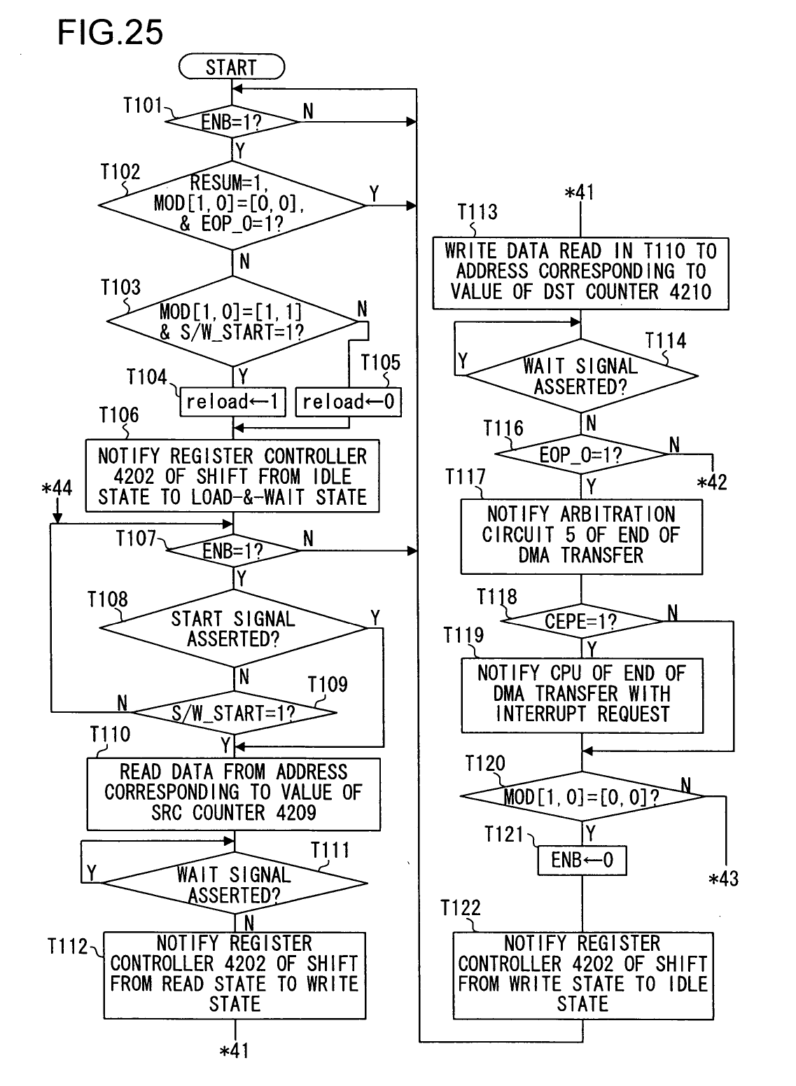

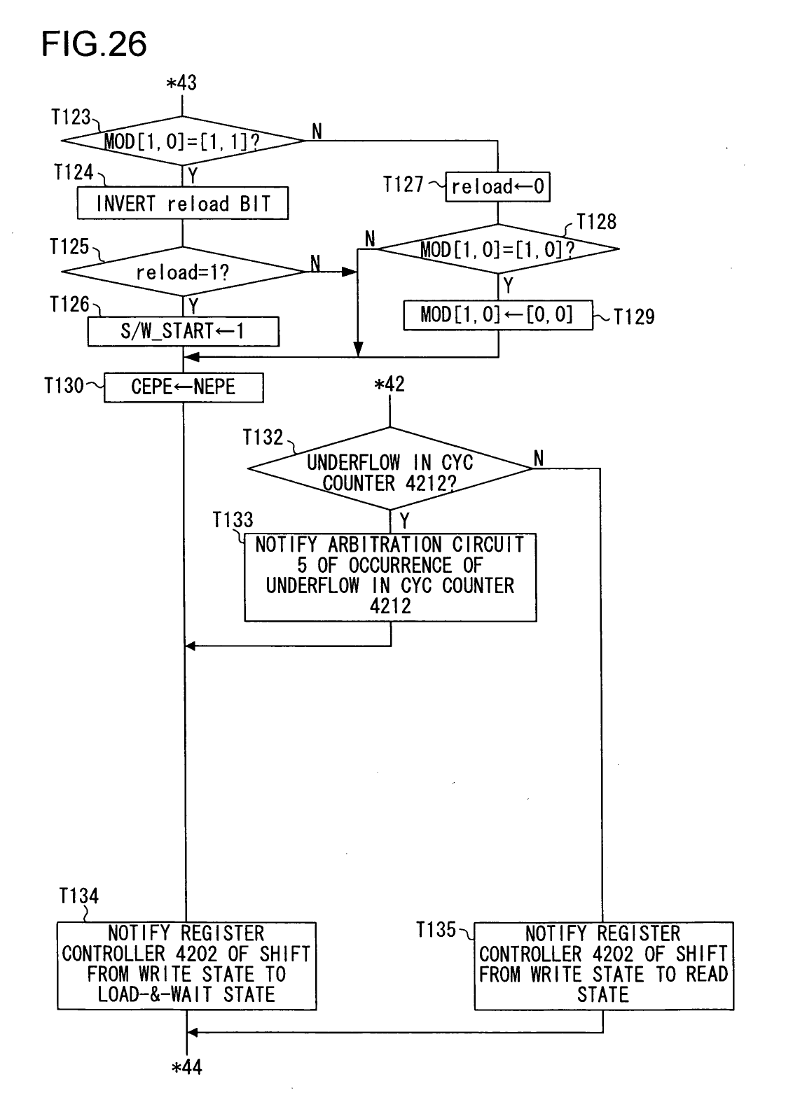

Now, the operation of the sequencer 4201 of a DMA channel will be described with reference to the flow charts shown in FIGS. 25 and 26. First, whether or not the ENB bit of the CTL register 4203 is “1” is checked (T101). If the ENB bit is “1” (“Y” in T101), the flow proceeds to T102. The ENB bit of the CTL register 4203 is a bit that indicates whether or not DMA transfer is permitted, and a “1” in this bit indicates that DMA transfer is permitted.

Incidentally, when the CPU completes making settings for DMA transfer on a DMA channel that is not currently being used, that is, when the CPU completes writing transfer conditions for DMA transfer to the CTL register 4203, SRC register 4204, DST register 4205, CYC register 4206, TRN register 4207, and SET register 4208, it sets the ENB bit of the CTL register 4203 to “1.”

In T102, whether or not the RESUM bit, MOD1 bit, and MOD0 bit of the CTL register 4203 are “1,” “0” and “0,” respectively and in addition the EOP_O bit of the register provided within the register controller 4202 is “1” is checked. If the check in T102 results in “yes” (“Y” in T102), the flow returns to T101 described above; on the other hand, if it results in “no” (“N” in T102), the flow proceeds to T103.

Incidentally, the CPU, after it has interrupted DMA transfer by setting the ENB bit of the CTL register 4203 to “0,” sets the RESUM bit of the CTL register 4203 to “1” prior to restarting DMA transfer by setting the ENB bit to “1.” That is, RESUM bit of the CTL register 4203 is a bit that indicates whether or not DMA transfer has been interrupted or not, and a “1” in this bit indicates that DMA transfer has been interrupted.

The MOD1 and MOD0 bits of the CTL register 4203 are bits that specify the mode in which DMA transfer is executed. The EOP_O bit of the register provided within the register controller 4202 is a bit that indicates whether or not DMA transfer has been completed, and a “1” in this bit indicates that DMA transfer has been completed

In T103, whether or not S/W_START bit of the CTL register 4203 is “1” and in addition the MOD1 and MOD0 bits are both “1” is checked. If the check in T103 results in “yes” (“Y” in T103), a reload bit of the CTL register 4203 is set to “1” (T104), and then the flow proceeds to T106. On the other hand, if the check in T103 results in “no” (“N” in T103), the reload bit is set to “0” (T105), and then the flow proceeds to T106.

Incidentally, the multiplexers 4220, 4221, 4222, 4223, and 4224 change their choices according to the reload bit. Specifically, when the reload bit is “0,” the multiplexers 4220, 4221, 4222, 4223, and 4224 choose the data stored in the SRC register 4204, DST register 4205, CYC register 4206, TRN register 4207, and SET register 4208, respectively; on the other hand, when the reload bit is “1,” the multiplexers choose the data stored in the RLD_SRC register 4215, RLD_DST register 4216, RLD_CYC register 4217, RLD_TRN register 4218, and RLD_SET register 4219, respectively.

In T106, the register controller 4202 is notified of a shift from an idle state to a load-and-wait state. On completion of T106, whether or not the ENB bit of the CTL register 4203 is “1” is checked (T107). If the ENB bit is “1”, (“Y” in T107), the flow proceeds to T108; on the other hand, if ENB bit is not “1”, (“N” in T107), the flow returns to T101 described above.

In T108, whether or not the start signal from the arbitration circuit 5 is asserted is checked. If the start signal is asserted (“Y” in T108), the flow proceeds to T110 described later; on the other hand, if the start signal is not asserted (“N” in T108), the flow proceeds to T109.

In T109, whether or not the S/W_START bit of the CTL register 4203 is “1” is checked. If the S/W_START bit is “1”, (“Y” in T109), the flow proceeds to T110; on the other hand, if the S/W_START bit is not “1”, (“N” in T109), the flow proceeds to T107 described above.

In T110, the data at the address corresponding to the value of the SRC counter 4209 is read to a buffer of the sequencer 4201 itself. On completion of T110, whether or not the wait signal from the arbitration circuit 5 is asserted is checked (T111). If the wait signal is not asserted (“N” in T111), the flow proceeds to T112.

In T112, the register controller 4202 is notified of a shift from a read state to a write state. On completion of T112, the data read in T110 is written to the address corresponding to the value of the DST counter 4210 (T110). Next, whether or not the wait signal is asserted is checked (T114), and, if the wait signal is not asserted (“N” in T114), the flow proceeds to T116.

In T116, whether or not the EOP_O bit of the register provided within the register controller 4202 is “1” is checked. If the EOP_O bit is “1”, (“Y” in T116), the arbitration circuit 5 is notified of the end of DMA transfer (T117); on the other hand, if the EOP_O bit is not “1,” (“N” in T116), the flow proceeds to T132 described later.

On completion of T117, whether or not the CEPE bit of the CTL register 4203 is “1” is checked (T118). If the CEPE bit is “1” (“Y” in T118), the CPU is notified, by means of an interrupt signal, that DMA transfer has been completed (T119), and then the flow proceeds to T120. On the other hand, if the CEPE bit is not “1” (“N” in T118), the flow skips T119 and proceeds directly to T120.

In T120, whether or not the MOD1 and MOD0 bits of the CTL register 4203 are both “0” is checked. If the check in T120 results in “yes” (“Y” in T120), the ENB bit of the CTL register 4203 is set to “0” (T121), and in addition the register controller 4202 is notified of a shift from a write state to an idle state (T122). On completion of T122, the flow proceeds to T101 described above. On the other hand, if the check in T120 results in “no” (“N” in T120), the flow proceeds to T123.

In T123, whether or not the MOD1 and MOD0 bits of the CTL register 4203 are both “1” is checked. If the cheek in T123 results in “yes” (“Y” in T123), the flow proceeds to T124; on the other hand, if the check in T123 results in “no” (“N” in T123), the flow proceeds to T127 described later.

In T124, the reload bit of the CTL register 4203 is inverted. On completion of T124, whether or not the reload bit is “1” is checked (T125). If the reload bit is “1” (“Y” in T125), the S/W_START bit of the CTL register 4203 is set to “1” (T126), and then the flow proceeds to T130 described later. On the other hand, if the reload bit is not “1” (“N” in T125), the flow skips T126 and proceeds directly to T130 described later.

In T127, to which the flow proceeds if the check in T123 results in “no” (“N” T123), the reload bit of the CTL register 4203 is set to “0.” On completion of T127, whether or not the MOD1 and MOD0 bits of the CTL register 4203 are “1” and “0,” respectively, is checked (T128).

If the check in T128 results in “yes” (“Y” in T128), the MOD1 and MOD0 bits are both set to “0” (T129), and then the flow proceeds to T130. On the other hand, if the check in T128 results in “no” (“N” in T128), the flow skips T129 and proceeds directly to T130.

In T130, the value of the CEPE bit of the CTL register 4203 is updated with the value of the NEPE bit of the CTL register 4203. On completion of T130, the register controller 4202 is notified of a shift from a write state to a load-and-wait state (T134). Then, the flow returns to T107 described above.

In T132, to which the flow proceeds if the check in T116 results in “no” (“N” in T116), whether or not an underflow is occurring in the CYC counter 4212 is checked. If an underflow is occurring in the CYC counter 4212 (“Y” in T132), the arbitration circuit 5 is notified of the occurrence of the underflow (T133), and the register controller 4202 is notified of a shift from a write state to a load-and-wait state (T134). On completion of T134, the flow returns to T107 described above.

On the other hand, if no underflow is occurring in the CYC counter 4212 (“N” in T132), the register controller 4202 is notified of a shift from a write state to a read state (T135). On completion of T135, the flow returns to T107 described above.

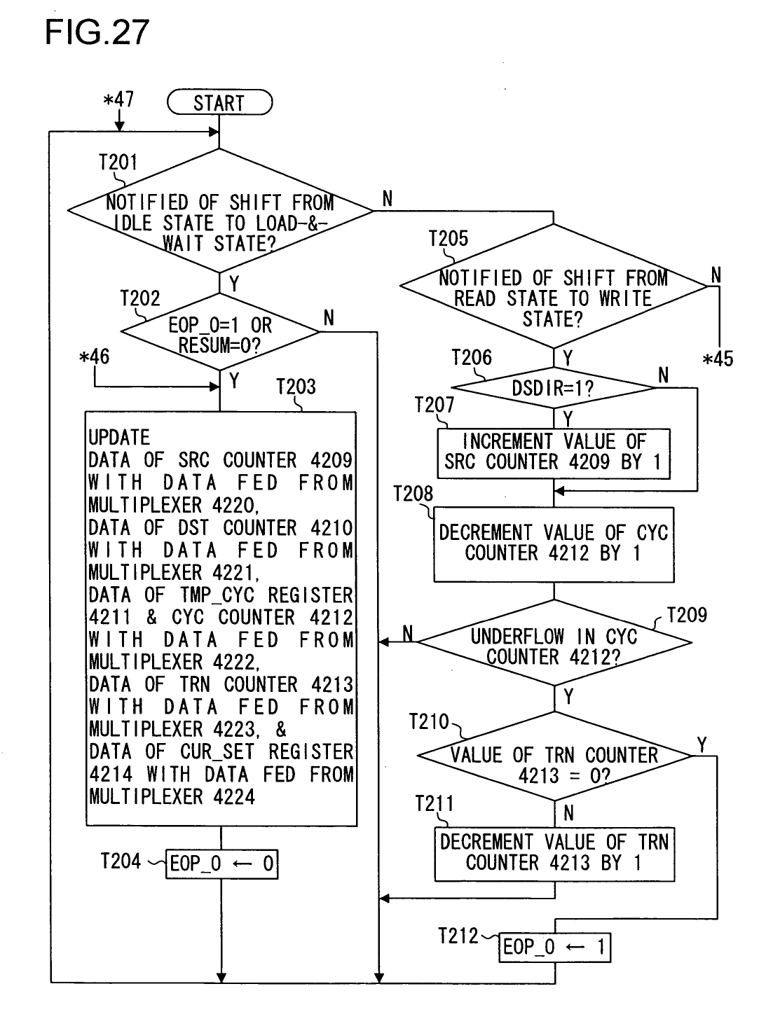

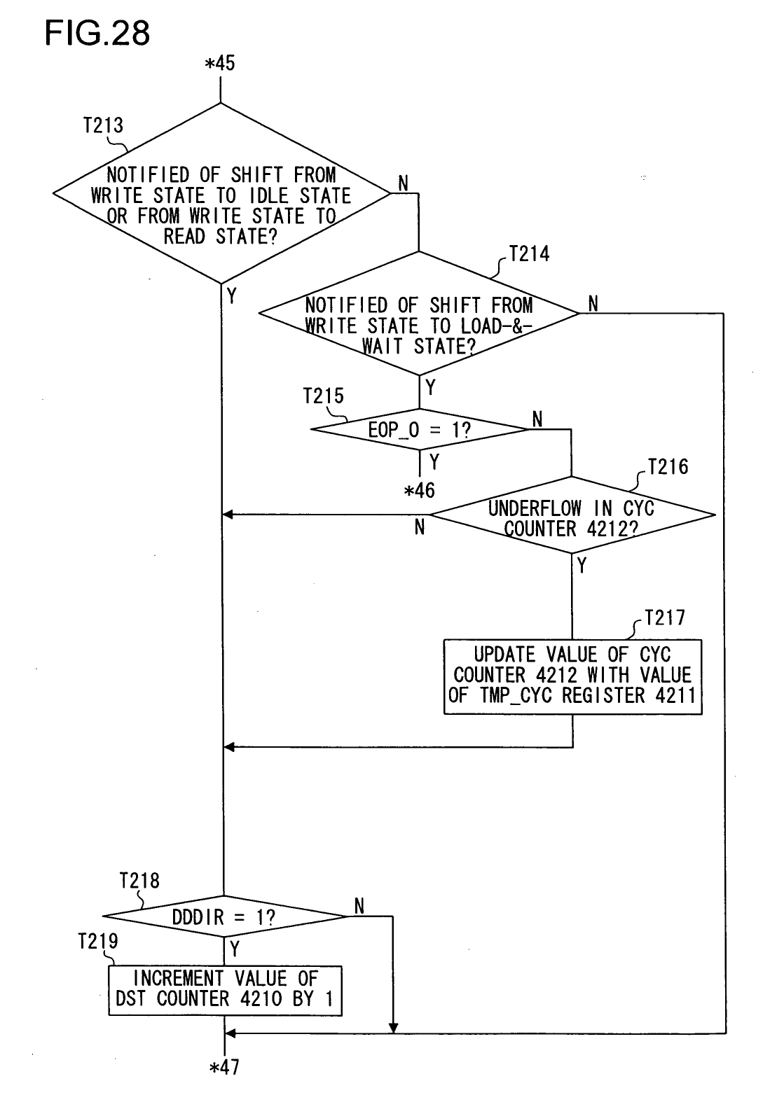

Now, the operation of the register controller 4202 will be described with reference to the flow charts shown in FIGS. 27 and 28. The register controller 4202 monitors notifications of shifts in status from the sequencer 4201 (T201, T205, T213, and T214).

First, a description will be given of a case where the register controller 4202 is notified, from the sequencer 4201, of a shift from an idle state to a load-and-wait state. In this case, the check in T201 results in “yes” (“Y” in T201), and whether or not the EOP_O bit of the register provided within the register controller 4202 itself is “1,” or whether or not the RESUM bit of the CTL register 4203 is “0,” is checked (T202).

If the check in T202 results in “yes” (“Y” in T202), the data of the SRC counter 4209 is updated with the data fed from the multiplexer 4220, the data of the DST counter 4210 is updated with the data fed from the multiplexer 4221, the data of the TMP_CYC register 4211 and the CYC counter 4212 is updated with the data fed from the multiplexer 4222, the data of the TRN counter 4213 is updated with the data fed from the multiplexer 4223, the data of the CUR_SET register 4214 is updated with the data fed from the multiplexer 4224 (T203). On completion of T203, the EOP_O bit of the register provided within the register controller 4202 itself is set to “0” (T204).

Next, a description will be given of a case where the register controller 4202 is notified, from the sequencer 4201, of a shift from a read state to a write state. In this case, the check in T205 results in “yes” (“Y” in T205), and whether or not a DSDIR bit of the CUR_SET register 4214 is “1” is checked (T206).

If the DSDIR bit is “1” (“Y” in T206”), the value of the SRC counter 4209 is incremented by one (T207), and then the flow proceeds to T208. On the other hand, if the DSDIR bit is not “1” (“N” in T206), the flow skips T207 and proceeds directly to T208.

In T208, the value of the CYC counter 4212 are decremented by one. On completion of T208, whether or not an underflow is occurring in the CYC counter 4212 is checked (T209). If an underflow is occurring in the CYC counter 4212 (“Y” in T209), whether or not the value of the TRN counter 4213 is “0” is checked (T210).

If the value of the TRN counter 4213 is not “0” (“N” in T210), the value of the TRN counter 4213 is decremented by one (T211). On the other hand, if the value of the TRN counter 4213 is “0” (“Y” in T210), the EOP_O bit of the register provided within the register controller 4202 itself is set to “1” (T212).

Next, a description will be given of a case where the register controller 4202 is notified, from the sequencer 4201, of a shift from a write state to an idle state or a shift from a write state to a read state. In this case, the check in T213 results in “yes” (“Y” in T213), and whether or not a DDDIR bit of the CUR_SET register 4214 is “1” is checked (T218). If the DDDIR bit is “1” (“Y” in T218), the value of the DST counter 4210 is incremented by one (T219).

Next, a description will be given of a case where the register controller 4202 is notified, from the sequencer 4201, of a shift from a write state to a load-and-wait state. In this case, the check in T214 results in “yes” (“Y” in T214), and whether or not the EOP_O bit of the register provided within the register controller 4202 itself is “1” is checked (T215).

If the EOP_O bit is “1” (“Y” in T215), the values of the SRC counter 4209, DST counter 4210, TMP_CYC register 4211 and CYC counter 4212, TRN counter 4213, and CUR_SET register 4214 are updated with the values of the SRC register 4204, DST register 4205, CYC register 4206, TRN register 4207, and SET register 4208, respectively (T203), and in addition the EOP_O bit of the register provided within the register controller 4202 itself is set to “0” (T204). On the other hand, if the EOP_O bit is not “1” (“N” in T215), whether or not an underflow is occurring in the CYC counter 4212 is checked (T216).

If an underflow is occurring in the CYC counter 4212 (“Y” in T216), the value of the CYC counter 4212 is updated with the value of the TMP_CYC register 4211 (T217), and then the flow proceeds to T218. On the other hand, if no underflow is occurring in the CYC counter 4212 (“N” in T216), the flow skips T217 and directly executes T218.

In T218, whether or not the DDDIR bit of the CUR_SET register 4214 is “1” is checked. If the DDDIR bit is “1” (“Y” in T218), the value of the DST counter 4210 is incremented by one (T219).

As the result of the sequencer 4201 and the register controller 4202 operating as described above, in each of the DMA channels, before DMA transfer is started, the values of the group of setting registers (the SRC register 4204, DST register 4205, CYC register 4206, TRN register 4207, and SET register 4208) are written to the group of operation registers (the SRC counter 4209, DST counter 4210, TMP_CYC register 4211, CYC counter 4212, TRN counter 4213, and CUR_SET register 4214), and DMA transfer is executed according to the values of the group of operation registers.

Thus, by writing transfer conditions for DMA transfer to the group of setting registers, it is possible to make settings for DMA transfer even on a DMA channel that is currently being used. Accordingly, when DMA transfer needs to be executed in a given task, even when all the DMA channels are currently being used, it is possible to make settings for DMA transfer without waiting for the end of DMA transfer. This helps reduce the wasting of the CPU's processing time resulting from task switching and the like.

According to the MOD1 and MOD0 bits of the CTL register 4203, a DMA channel operates in different modes as described below. On completion of DMA transfer, if the MOD1 and MOD0 bits are both set to “0,” the DMA channel goes into an idle state (in which DMA transfer is inhibited) (hereinafter referred to as the “normal mode 4”).

On completion of DMA transfer, if the MOD1 and MOD0 bits are set to “0” and “1,” respectively, the DMA channel goes into a load-and-wait state (in which the DMA channel, having updated the values of the group of operation registers with those of the group of setting registers, is waiting for a request for DMA transfer). Thus, the next DMA transfer is started without intervention of the CPU (hereinafter referred to as the “autorepeat mode 4”).

On completion of DMA transfer, if the MOD1 and MOD0 bits are set to “1” and “0,” respectively, the DMA channel sets both the MOD1 and MOD0 bits to “0” and then goes into a load-and-wait state. Thus, the next DMA transfer is started without intervention of the CPU, and then, on completion of this DMA transfer, the DMA channel goes into an idle state (hereinafter referred to as the “autostart mode 4”).

Accordingly, the CPU has only to rewrite the MOD1 and MOD0 bits of the CTL register 4203 to make the individual DMA channels change their operation mode in such a way that: when settings for DMA transfer are made on a DMA channel that is not currently being used, the DMA channel operates in the normal mode 4; when DMA transfer needs to be executed repeatedly with the same settings, the relevant DMA channel operates in the autorepeat mode 4; and, when settings for DMA transfer are made on a DMA channel that is currently being used, the DMA channel operates in the autostart mode 4.

When execution of DMA transfer becomes permitted (i.e., when the ENB bit of the CTL register 4203 is set to “1”), if the S/W_START, MOD1, and MOD0 bits of the CTL register 4203 are all “1,” the transfer conditions under which to transfer by DMA transfer from the RAM 4400 to the group of setting registers the transfer conditions under which to execute DMA transfer is read from a group of setting execution registers (the RLD_SRC register 4215, RLD_DST register 4216, RLD_CYC register 4217, RLD_TRN register 4218, and RLD_SET register 4219) to the group of operation registers, and then, according to the values of the group of operation registers, DMA transfer is executed. Thus, the transfer conditions for DMA transfer is transferred by DMA transfer from the RAM 4400 to the group of setting registers. Thereafter, while the MOD1 and MOD0 bits are both “1,” the operation of transferring, by DMA transfer, transfer conditions for DMA transfer from the RAM 4400 to the group of setting register and the operation of executing DMA transfer according to the transfer conditions transferred, by DMA transfer, from the RAM 4400 to the group of setting registers are executed alternately (hereinafter referred to as the “reload mode 4”).

In this reload mode 4, all that needs to be performed to execute all desired DMA transfer sessions is to write the transfer conditions for the individual DMA transfer sessions to the RAM 4400 as an example is shown in FIG. 24, then set the S/W_START, MOD1, and MOD0 bits of the CTL register 4203 all to “1,” then write to the RLD_SRC register 4215 the start address (in the example shown in FIG. 5, 20000000H) in the RAM 4400 where the transfer conditions relating to the first DMA transfer session are stored, and then set the ENB bit of the CTL register 4203 to “1.” Thus, settings for a plurality of DMA transfer sessions can be made at a time.

Accordingly, when the CPU wants to set the DMA channels for a plurality of DMA transfer sessions, it can use the reload mode 4 and thereby reduce the processing time used to make settings for DMA transfer.

On completion of DMA transfer, if the CEPE bit of the CTL register 4203 is “0,” no interrupt request is sent to the CPU to notify it of the end of DMA transfer. Thus, when the CPU has made settings for the next DMA transfer, so long as the CEPE bit is set to “0,” the CPU does not receive an interrupt request from the DMA controller even at the end of the immediately previously set DMA transfer. This helps eliminate meaningless interrupt requests from the DMA controller and thereby save more time for other operations.

When the CPU has access to the system bus 4300, it can rewrite the values of the CTL register 4203 at any time to switch the operation mode of the DMA channels and whether or not to send an interrupt request on completion of DMA transfer. This makes it possible to flexibly cope with varying situations.

Let the value set in the CYC register 4206 be p, and let the value set in the TRN register 4207 be q. Then, every time DMA transfer is requested, (p+1) DMA transfer cycles are executed, and thereafter a stand-by state prevails until a new request for DMA transfer occurs. Eventually, when DMA transfer is completed in response to the (q+1)th request for DMA transfer, the entire operation is ended. That is, (q+1) DMA transfer sessions each consisting of (p+1) cycles are executed.

Accordingly, when the CPU wants to execute B DMA transfer sessions each consisting of A cycles, it has only to set, only once, the values of the CYC register 4206 and the TRN resistor to A−1 and B−1, respectively. This helps reduce the burden on the CPU, and thus helps alleviate the lowering of system performance.

In a data processing apparatus such as a personal computer having a CPU for executing a program and a memory for storing data or for storing data and the program wherein the data can be read out from the memory through a data processing control apparatus such as a DMA controller, it is possible to use, as the data processing control apparatus such as a DMA controller, any of the data processing control apparatuses or DMA controllers described hereinbefore as the first to fourth embodiments.

What is claimed is:

1. A data processing control apparatus that alternatively makes one among a plurality of service executers each designed to execute predetermined service execute service, comprising:
a controller for performing control so that whichever of the service executers requested to execute service is given a highest order of priority executes service;
a priority updater for updating orders of priority given to the individual service executers in such a way that, every time a given service executer has continuously executed an amount of service that a single service executer is permitted to continuously execute, the given service executer is given a lowest order of priority; and
a memory for storing, for each of the service executers, data indicating amount of service that a single service executer is permitted to continuously execute.

2. A DMA controller comprising:
a setting register for permitting a CPU to make settings for DMA transfer therein;
an operation register for permitting data stored in the setting register to be written thereto, or an operation counter for performing counting operation by use of the data;
an operation controller for performing control so that, when DMA transfer is started, the data stored in the setting register is written to the operation register or the operation counter; and
a transfer executer for executing DMA transfer based on the data stored in the operation register or the operation counter.

3. A DMA controller comprising:
an operation register for storing transfer conditions under which DMA transfer is currently being executed;
a setting register for storing transfer conditions under which DMA transfer is to be executed next time;
a setting execution register for storing transfer conditions under which to transfer, by DMA transfer, transfer conditions for DMA transfer from an external memory to the setting register;
a selector for alternatively selecting one of the setting register and the setting execution register;
a selection controller for performing control so that the register selected by the selector is switched alternately between the setting register and the setting execution register every time DMA transfer ends;
an operation register controller for performing control so that, when DMA transfer is started, data stored in the register selected by the selector is written to the operation register; and
a transfer executer for executing DMA transfer based on the data stored in the operation register.

4. A data processing apparatus comprising a CPU for executing a program and a memory for storing data or for storing data and the program wherein the data can be read out from the memory through a data processing control apparatus,
the data processing control apparatus alternatively making one among a plurality of service executers each designed to execute predetermined service execute service,
the data processing control apparatus comprising:
a controller for performing control so that whichever of the service executers requested to execute service is given a highest order of priority executes service;
a priority updater for updating orders of priority given to the individual service executers in such a way that, every time a given service executer has continuously executed an amount of service that a single service executer is permitted to continuously execute, the given service executer is given a lowest order of priority; and
a memory for storing, for each of the service executers, data indicating amount of service that a single service executer is permitted to continuously execute.

5. A data processing apparatus comprising a CPU for executing a program and a memory for storing data or for storing data and the program wherein the data can be read out from the memory through a DMA controller,
the DMA controller comprising:
a setting register for permitting a CPU to make settings for DMA transfer therein;
an operation register for permitting data stored in the setting register to be written thereto, or an operation counter for performing counting operation by use of the data;
an operation controller for performing control so that, when DMA transfer is started, the data stored in the setting register is written to the operation register or the operation counter; and
a transfer executer for executing DMA transfer based on the data stored in the operation register or the operation counter.

6. A data processing apparatus comprising a CPU for executing a program and a memory for storing data or for storing data and the program wherein the data can be read out from the memory through a DMA controller,
the DMA controller comprising:
an operation register for storing transfer conditions under which DMA transfer is currently being executed;
a setting register for storing transfer conditions under which DMA transfer is to be executed next time;
a setting execution register for storing transfer conditions under which to transfer, by DMA transfer, transfer conditions for DMA transfer from an external memory to the setting register;
a selector for alternatively selecting one of the setting register and the setting execution register;
a selection controller for performing control so that the register selected by the selector is switched alternately between the setting register and the setting execution register every time DMA transfer ends;
an operation register controller for performing control so that, when DMA transfer is started, data stored in the register selected by the selector is written to the operation register; and
a transfer executer for executing DMA transfer based on the data stored in the operation register.
